(19) United States
(12) Patent Application Publication
(10) Pub. No.: US 2025/0028688 A1
(43) Pub. Date: Jan. 23, 2025

(54) USER INTERFACES FOR MESSAGES AND SHARED DOCUMENTS

(71) Applicant: Apple Inc., Cupertino, CA (US)

(72) Inventors: Jae Woo CHANG, Cupertino, CA (US); Zheng X. HONG, San Jose, CA (US); Mani AMINI, Santa Cruz, CA (US); Devin O. CLARY, Scotts Valley, CA (US); Alexandre S. LACOUR, San Francisco, CA (US); Elliot A. BARER, Sunnyvale, CA (US); Stephen M. LOTTERMOSER, San Jose, CA (US); Gabriella Yang SAUCIER, Mountain View, CA (US)

(21) Appl. No.: 18/904,945

(22) Filed: Oct. 2, 2024

Related U.S. Application Data
(63) Continuation of application No. 18/328,704, filed on Jun. 2, 2023.
(60) Provisional application No. 63/365,857, filed on Jun. 3, 2022.

(51) Int. Cl. G06F 16/176; G06F 16/178; H04L 51/212

(52) U.S. Cl. CPC G06F 16/176; G06F 16/1794; H04L 51/212

(57) ABSTRACT

Some embodiments described in this disclosure are directed to electronic devices that present indications of changes to a shared document and/or to the users in a messaging conversation while displaying the messaging conversation. Some embodiments described in this disclosure are directed to electronic devices that present options to update the users with access to shared documents and/or messaging conversations. Some embodiments described in this disclosure are directed to electronic devices that participate in communication sessions associated with a shared document.

### CROSS-REFERENCE TO RELATED APPLICATIONS

This application is a continuation of U.S. application Ser. No. 18/328,704 filed Jun. 2, 2023 which claims the benefit of U.S. Provisional Application No. 63/365,857, filed Jun. 3, 2022, the content of which are incorporated herein by reference in their entireties for all purposes.

### FIELD OF THE DISCLOSURE

This relates generally to electronic devices that send and receive messages and present shared documents.

### BACKGROUND

User interaction with electronic devices has increased significantly in recent years. These devices can be devices such as computers, tablet computers, televisions, multimedia devices, mobile devices, and the like.

In some circumstances, users wish to view indications of changes to a shared document and/or to the users in a messaging conversation while displaying the messaging conversation. In some circumstances, users wish to update the users that have access to shared documents and/or messaging conversations. In some circumstances, users wish to participate in communication sessions associated with a shared document. Enhancing these interactions improves the user's experience with the device and decreases user interaction time, which is particularly important where input devices are battery-operated.

### SUMMARY

Some embodiments described in this disclosure are directed to electronic devices that present indications of changes to a shared document and/or to the users in a messaging conversation while displaying the messaging conversation. Some embodiments described in this disclosure are directed to electronic devices that present options to update the users with access to shared documents and/or messaging conversations. Some embodiments described in this disclosure are directed to electronic devices that participate in communication sessions associated with a shared document.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates a block diagram of an exemplary architectures for devices according to some embodiments of the disclosure.

FIGS. 6A-6G illustrate exemplary ways of presenting indications of changes to a shared document and/or to the users in a messaging conversation while displaying the messaging conversation in accordance with some embodiments of the disclosure.

FIG. 7 is a flowchart illustrating an exemplary method of presenting indications of changes to a shared document and/or to the users in a messaging conversation while displaying the messaging conversation in accordance with some embodiments of the disclosure.

FIGS. 8A-8W illustrate exemplary ways of presenting options to update the users with access to shared documents and/or messaging conversations in accordance with some embodiments of the disclosure.

FIGS. 9A-9B is a flowchart illustrating an exemplary method of presenting options to update the users with access to shared documents and/or messaging conversations in accordance with some embodiments of the disclosure.

FIGS. 10A-10G illustrate exemplary ways of participating in communication sessions associated with a shared document in accordance with some embodiments of the disclosure.

FIG. 11 is a flowchart illustrating an exemplary method of participating in communication sessions associated with a shared document in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for presenting indications of changes to a shared document and/or to the users in a messaging conversation while displaying the messaging conversation. In some embodiments, an electronic device has access to a shared document and a messaging conversation associated with the shared document. In some embodiments, in response to detecting a change to the shared document and/or a change to the users that are able to access the messaging conversation, the electronic device presents an indication of the change in the user interface that includes the messaging conversation. Such techniques can reduce the cognitive burden on a user who uses such devices. Further, such techniques can reduce processor and battery power otherwise wasted on redundant user inputs.

There is a need for electronic devices that provide efficient methods for presenting options to update the users with access to shared documents and/or messaging conversations. In some embodiments, an electronic device receives an input to add or remove a user from the shared document or the messaging conversation. In some embodiments, in response to receiving the input, the electronic device presents a selectable option that, when selected, causes the electronic device to add or remove the user from the other of the shared document or the messaging conversation. In some embodiments, adding or removing users from both the messaging conversation and the shared document, rather than adding or removing users from one or the other, causes the groups of users with access to the shared document and the messaging conversation to be the same. Such techniques can reduce the cognitive burden on a user who uses such devices. Further, such techniques can reduce processor and battery power otherwise wasted on redundant user inputs.

There is a need for electronic devices that provide efficient methods for participating in communication sessions associated with a shared document. In some embodiments, while participating in a communication session, such as a phone call or a video conference, the electronic device displays a selectable option that, when selected, causes the electronic device to display a shared document. In some embodiments, the electronic device shares documents using communication sessions that include the selectable option to access the shared document. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

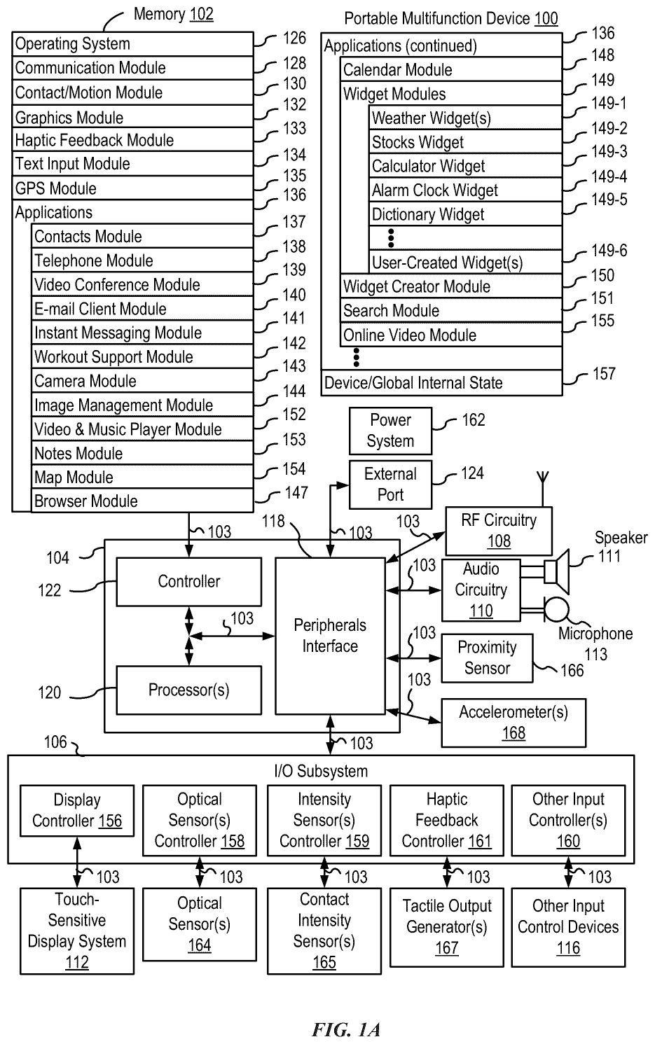

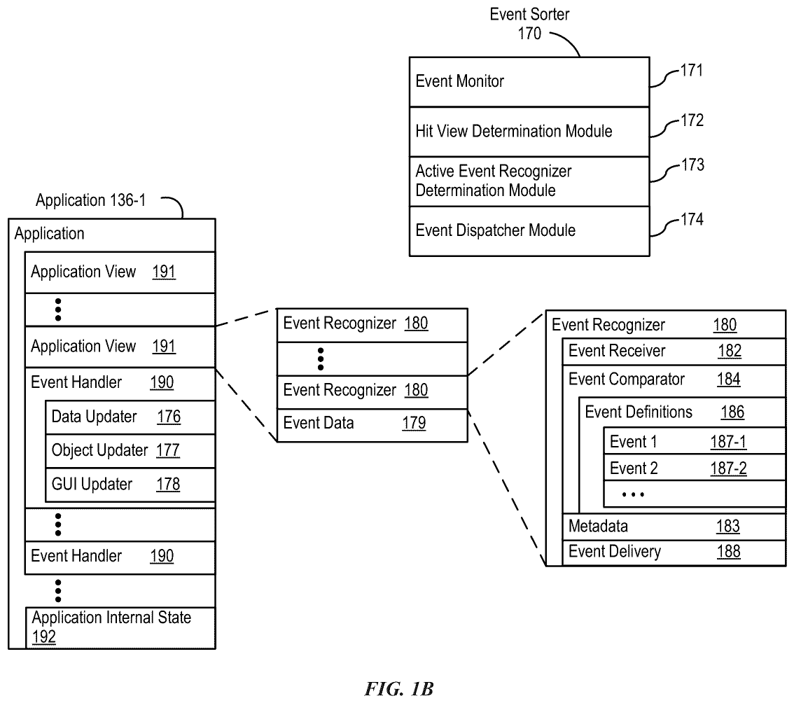

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

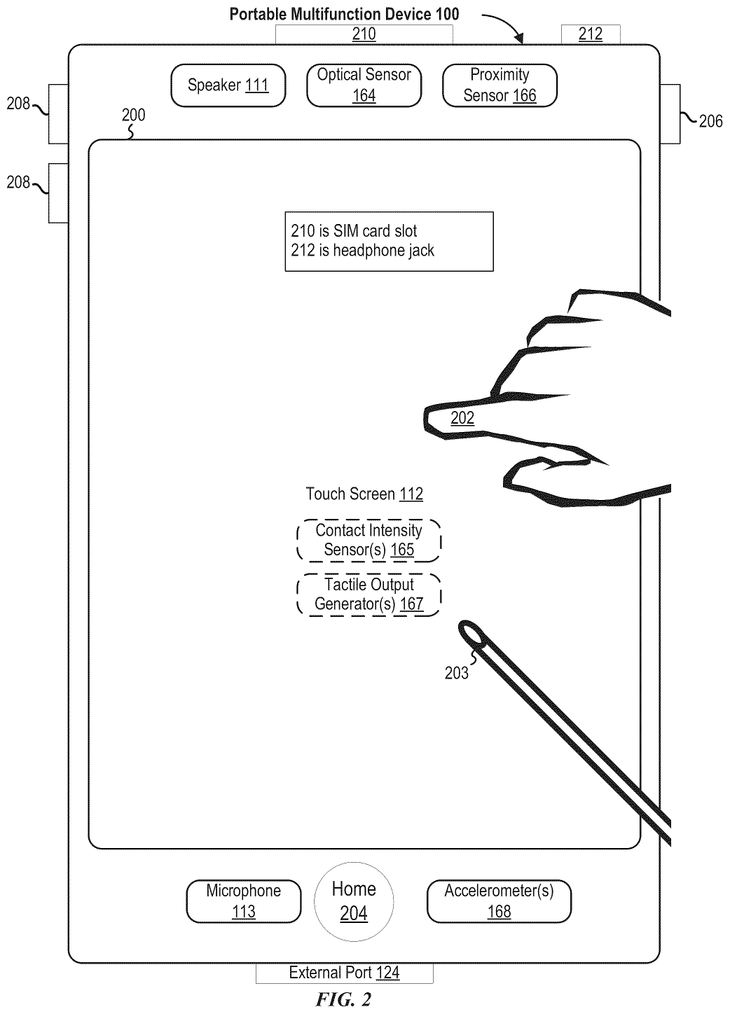

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, device 100 is a portable computing system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system (e.g., an integrated display, touch screen 112, etc.). In some embodiments, the display generation component is separate from the computer system (e.g., an external monitor, a projection system, etc.). As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piczoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

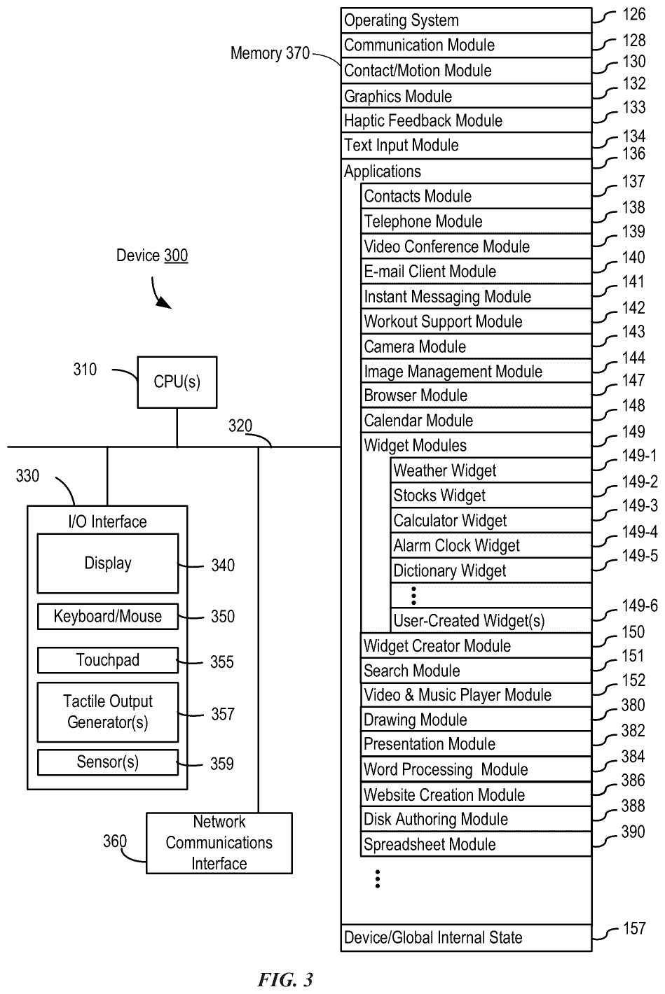

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail client module 140, IM 141, browser 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

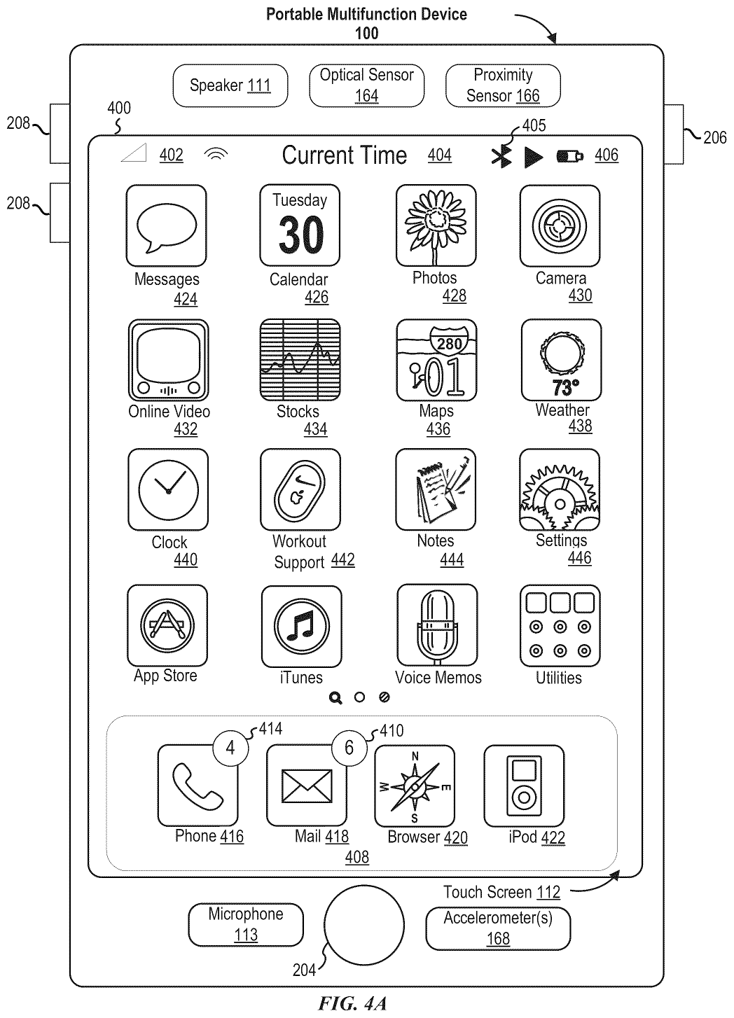

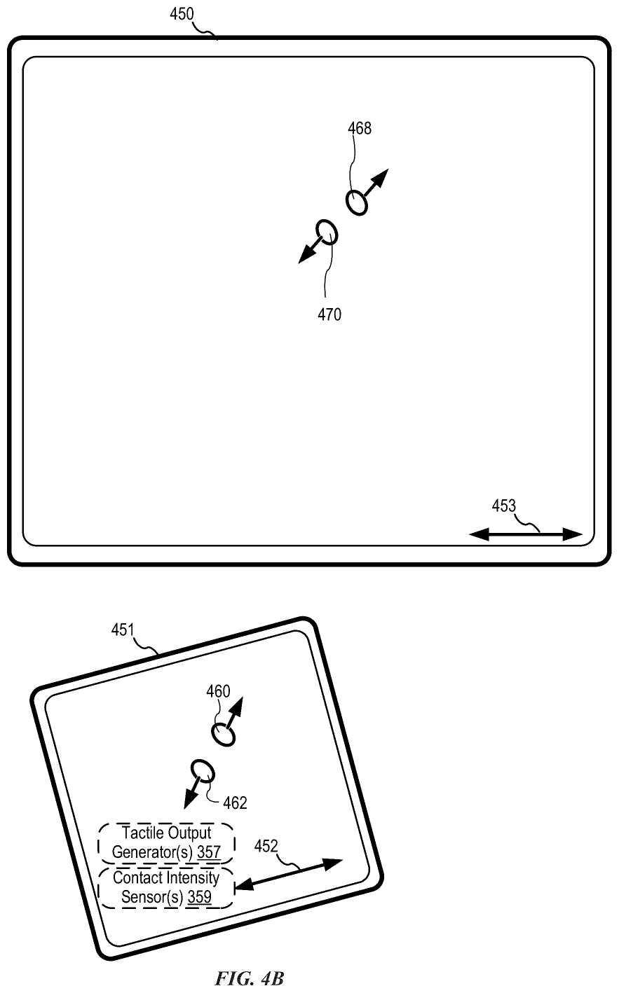

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

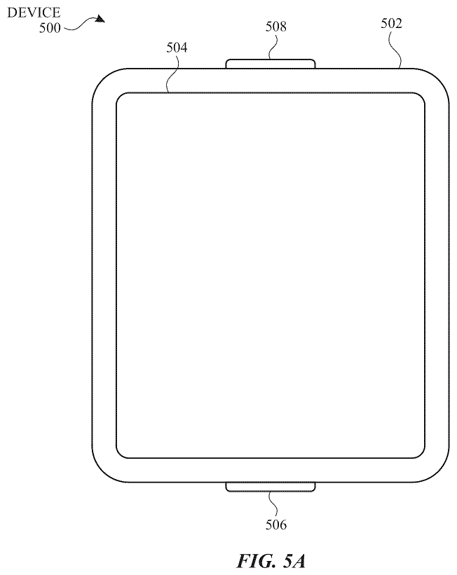

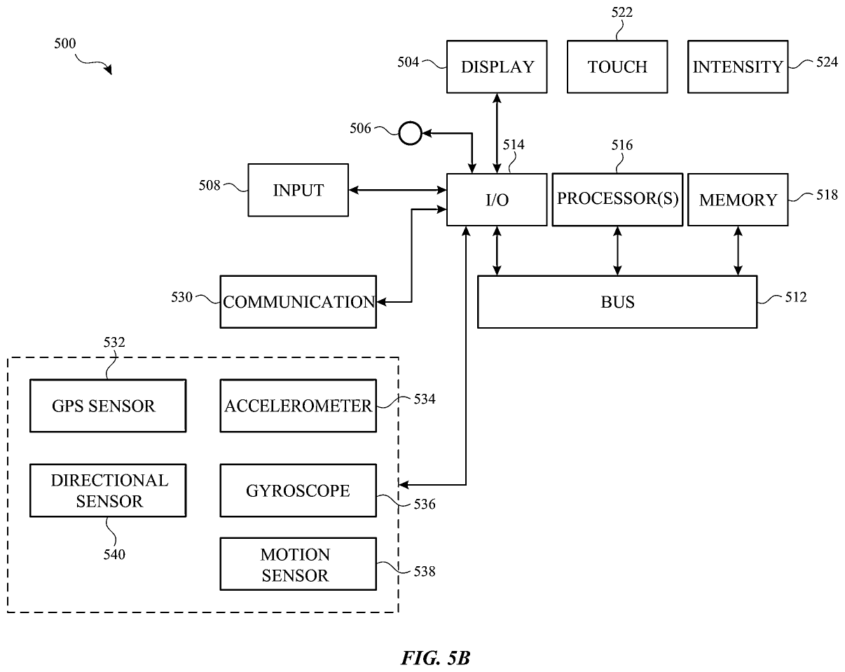

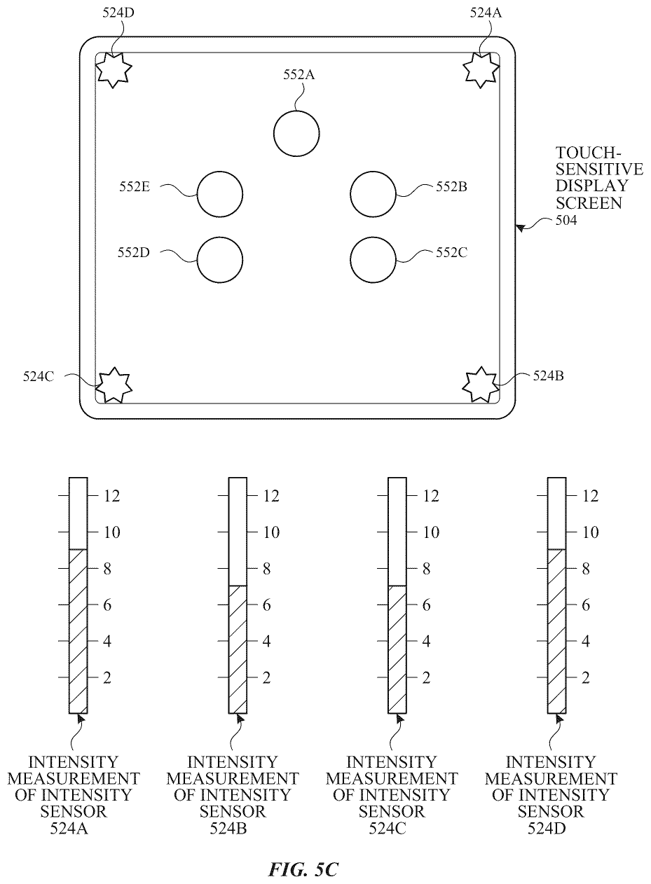

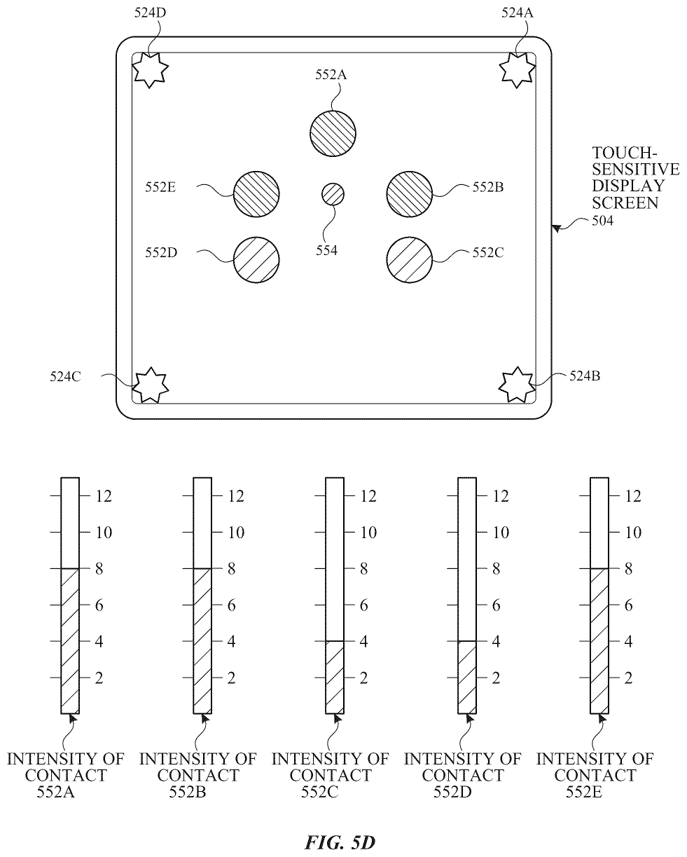

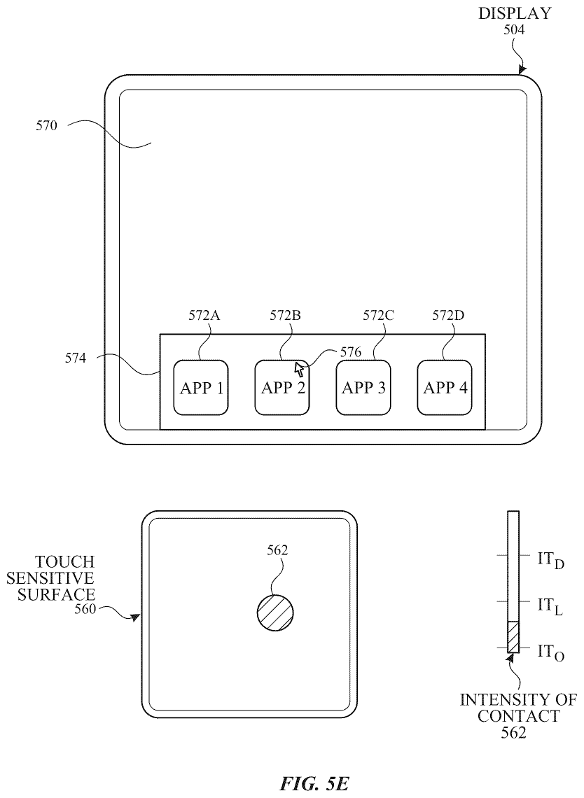

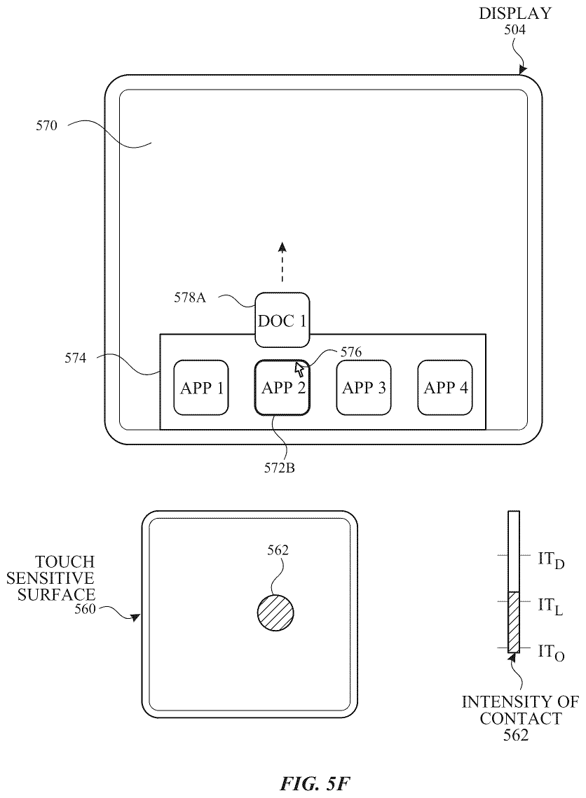

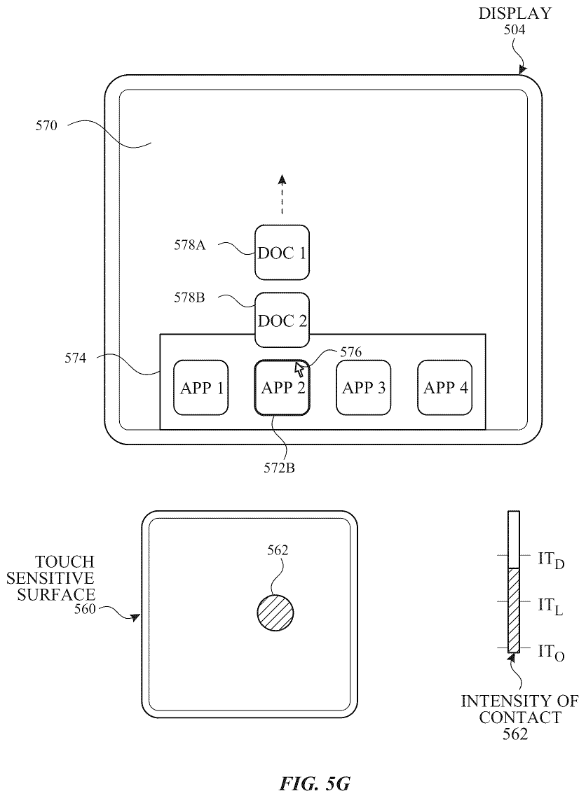

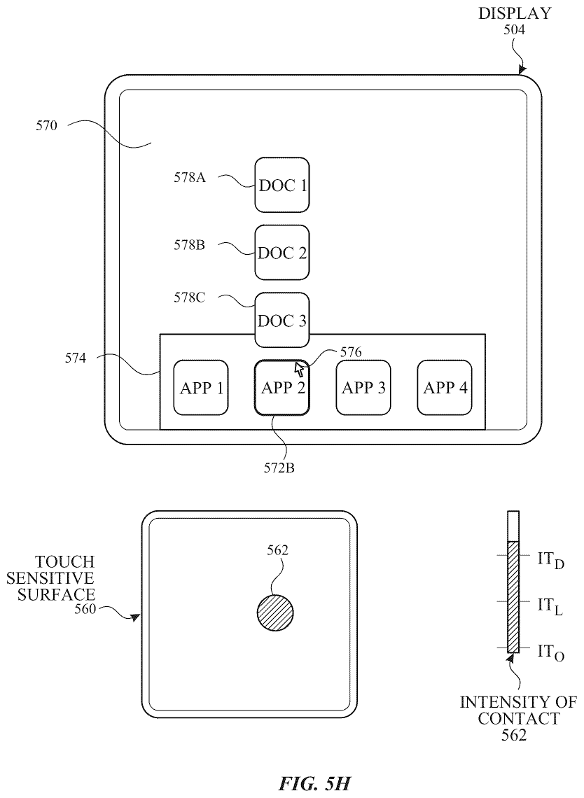

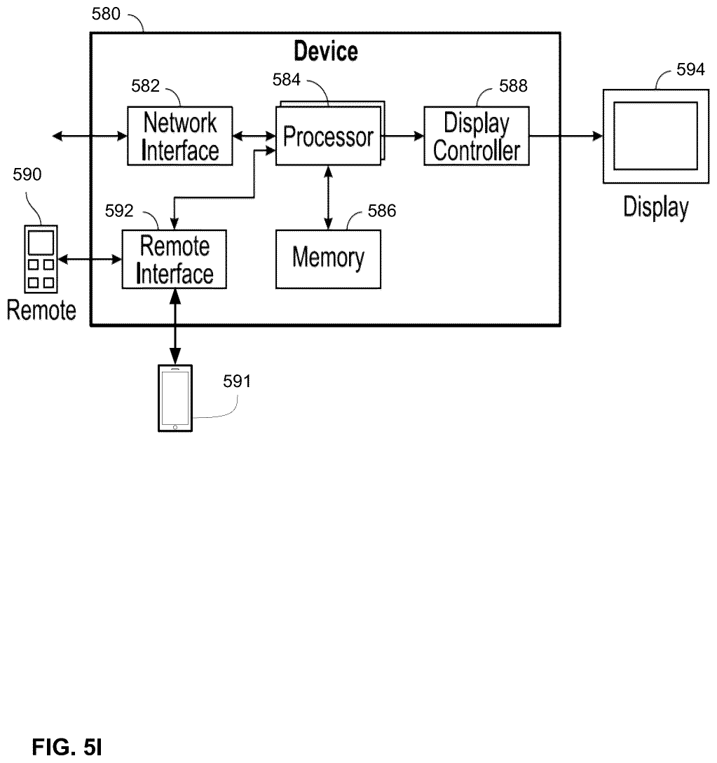

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

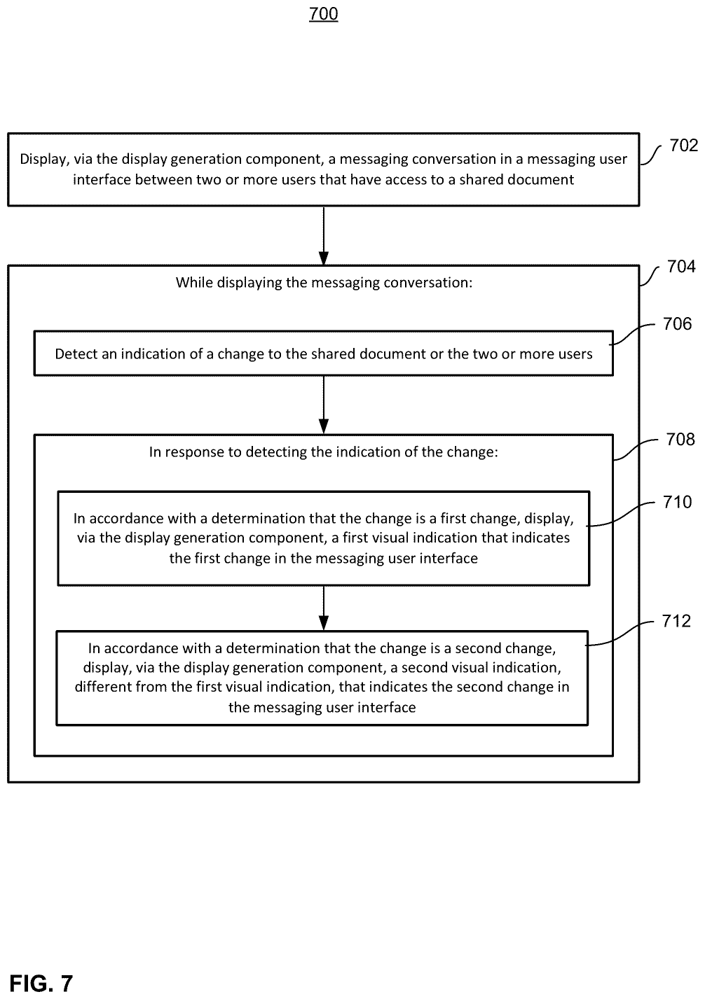

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 1100 (FIGS. 7, 9A-9B, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5I. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

FIG. 5I illustrates a block diagram of an exemplary architecture for the device 580 according to some embodiments of the disclosure. In the embodiment of FIG. 5I, media or other content is optionally received by device 580 via network interface 582, which is optionally a wireless or wired connection. The one or more processors 584 optionally execute any number of programs stored in memory 586 or storage, which optionally includes instructions to perform one or more of the methods and/or processes described herein (e.g., methods 700 and 900).

In some embodiments, display controller 588 causes the various user interfaces of the disclosure to be displayed on display 594. Further, input to device 580 is optionally provided by remote 590 via remote interface 592, which is optionally a wireless or a wired connection. In some embodiments, input to device 580 is provided by a multifunction device 591 (e.g., a smartphone) on which a remote control application is running that configures the multifunction device to simulate remote control functionality, as will be described in more detail below. In some embodiments, multifunction device 591 corresponds to one or more of device 100 in FIGS. 1A and 2, device 300 in FIG. 3, and device 500 in FIG. 5A. It is understood that the embodiment of FIG. 5I is not meant to limit the features of the device of the disclosure, and that other components to facilitate other features described in the disclosure are optionally included in the architecture of FIG. 5I as well. In some embodiments, device 580 optionally corresponds to one or more of multifunction device 100 in FIGS. 1A and 2, device 300 in FIG. 3, and device 500 in FIG. 5A; network interface 582 optionally corresponds to one or more of RF circuitry 108, external port 124, and peripherals interface 118 in FIGS. 1A and 2, and network communications interface 360 in FIG. 3; processor 584 optionally corresponds to one or more of processor(s) 120 in FIG. 1A and CPU(s) 310 in FIG. 3; display controller 588 optionally corresponds to one or more of display controller 156 in FIG. 1A and I/O interface 330 in FIG. 3; memory 586 optionally corresponds to one or more of memory 102 in FIG. 1A and memory 370 in FIG. 3; remote interface 592 optionally corresponds to one or more of peripherals interface 118, and I/O subsystem 106 (and/or its components) in FIG. 1A, and I/O interface 330 in FIG. 3; remote 590 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4; and, display 594 optionally corresponds to one or more of touch-sensitive display system 112 in FIGS. 1A and 2, and display 340 in FIG. 3.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For case of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Indicating Document and Message Updates

Users interact with electronic devices in many different manners. In some embodiments, an electronic device presents a shared document accessible to a group of users and a messaging conversation between the group of users. The embodiments described below provide ways in which an electronic device displays visual indications of changes made to the document and/or messaging conversation while displaying the messaging conversation. For example, the electronic device displays indications that the shared document was edited and/or indications of changes to the users in the messaging conversation. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

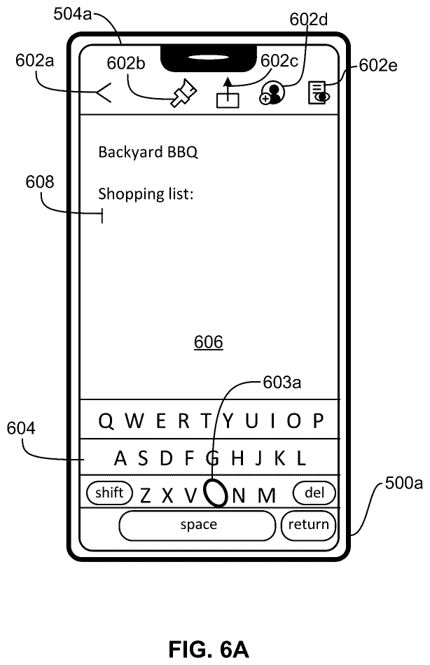

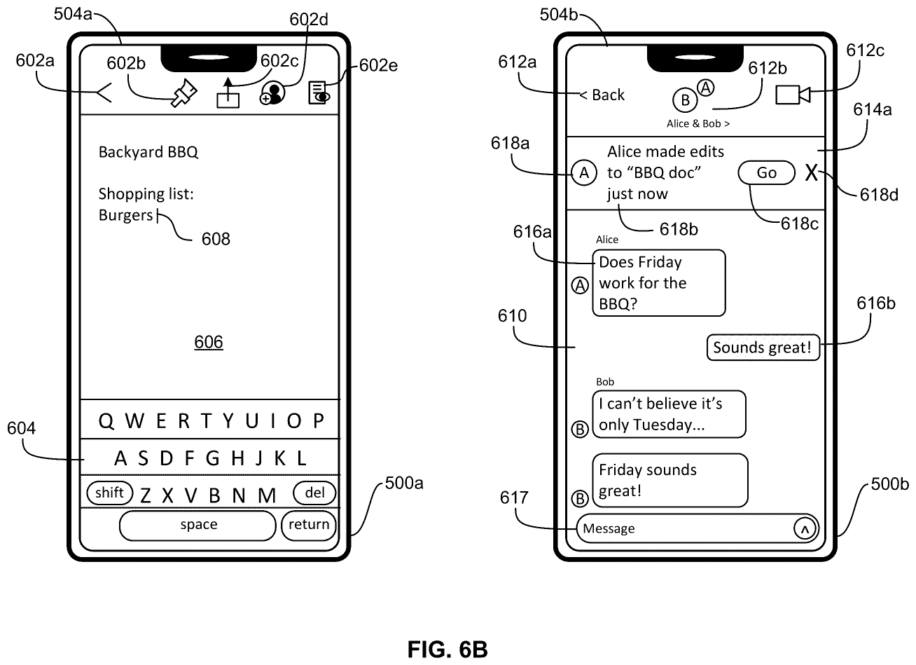

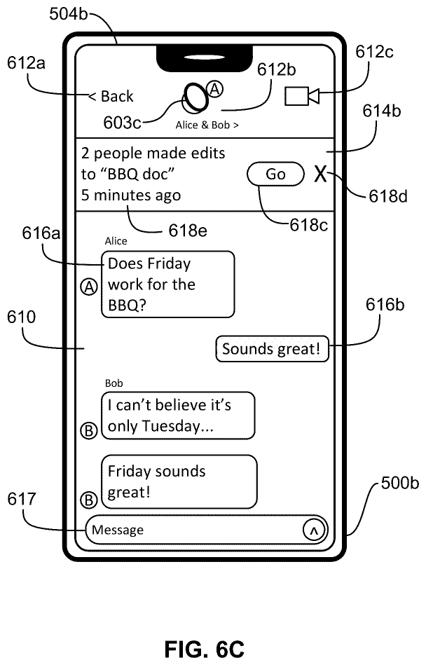

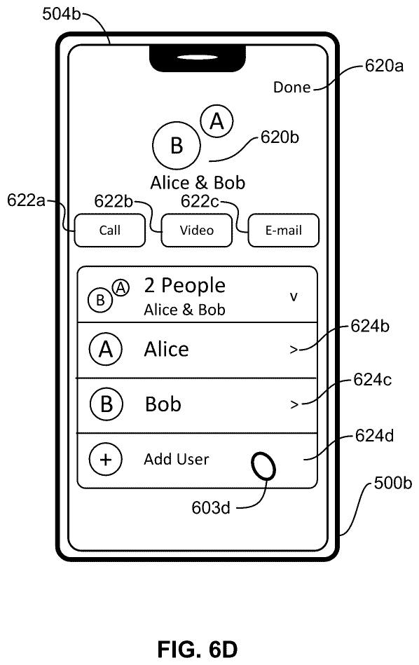

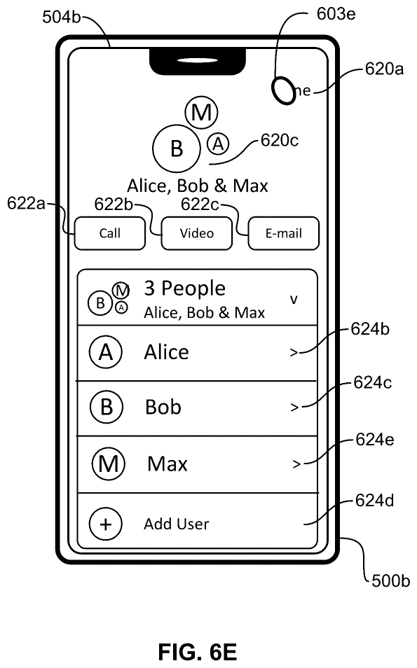

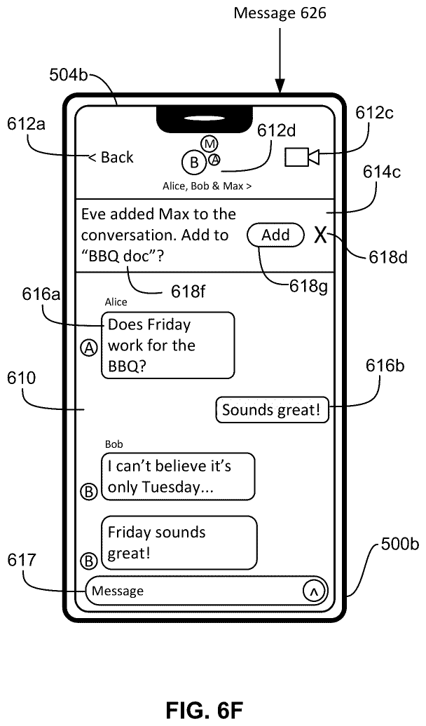

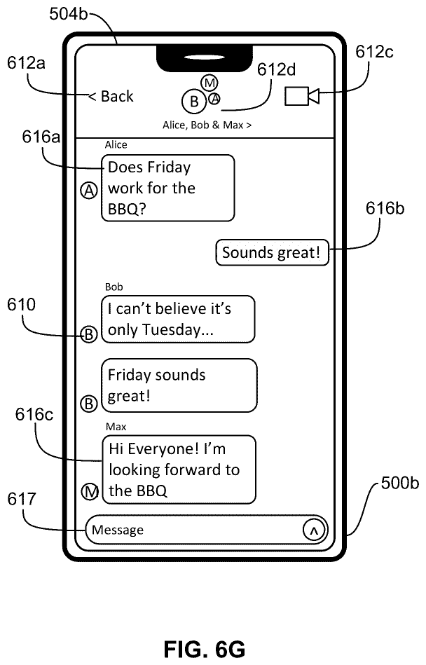

FIGS. 6A-6G illustrate exemplary ways of presenting indications of changes to a shared document and/or to the users in a messaging conversation while displaying the messaging conversation in accordance with some embodiments of the disclosure. The embodiments in these figures are used to illustrate the processes described below, including the processes described with reference to FIG. 7.

FIG. 6A illustrates the electronic device 500 displaying a shared document 606. In some embodiments, the shared document 606 is displayed in a user interface of a document viewing and/or editing application. In some embodiments, the user interface further includes an option 602a to navigate back in the user interface to a previously-displayed user interface and to cease displaying the shared document 606. In some embodiments, the user interface further includes a formatting option 602b that, when selected, causes the electronic device 500a to display a menu for changing the formatting settings of the text in the shared document 606, such as font and/or paragraph style, font size, and the use of bullets. In some embodiments, the user interface further includes an option 602d to display a menu for sharing the shared document, as described in more detail below with reference to one or more of methods 900 and/or 1100. In some embodiments, the user interface includes a proofreading option 602e that, when selected, causes the electronic device 500a to initiate a process to check spelling and/or grammar errors in the shared document 606. In some embodiments, the user interface further includes a soft keyboard 604. In some embodiments, in response to one or more inputs directed to the soft keyboard 604, the electronic device 500a enters text into the shared document 606 at the location of cursor 608. For example, as shown in FIG. 6A, the electronic device 500a detects an input (e.g., including contact 603a) directed to the soft keyboard 604. In response to a sequence of inputs including the input illustrated in FIG. 6A, the electronic device 500a enters additional text to the shared document 606, as shown in FIG. 6B.

FIG. 6B illustrates an example of the electronic device 500a updating the shared document 606 in response to a sequence of inputs directed to soft keyboard 604, including the input illustrated in FIG. 6A. FIG. 6B also includes a second electronic device 500b that has access to the shared document 606 and a messaging conversation that includes the user of the electronic device 500a and/or one or more additional users that have access to the shared document 606. In some embodiments, the second electronic device 500b displays the messaging conversation in a messaging application user interface 610. In some embodiments, the messaging application user interface 610 includes a representation 616a of a message from another user in the conversation and a representation 616b of a message from the user of the second electronic device 500b. In some embodiments, the messaging application user interface 610 further includes an option 612a that, when selected, causes the second electronic device 500b to navigate back in the messaging application to a previously-displayed user interface. In some embodiments, the messaging application user interface 610 further includes an option 612b to view a settings user interface associated with the messaging conversation. In some embodiments, the messaging application user interface 610 includes an option 612c that, when selected, causes the second electronic device 500b to initiate a videoconference between the users in the messaging conversation. In some embodiments, the messaging application user interface 610 includes a message composition field 617 in which the second electronic device 500b displays text and/or images included in a draft message that, in response to receiving an input to send the message, the second electronic device 500b sends to the messaging conversation.

As shown in FIG. 6B, in some embodiments, in response to the first electronic device 500a editing the shared document 606, the second electronic device 500b displays an indication 614a of the revision to the shared document 606 by the electronic device 500a. In some embodiments, the indication 614a includes an indication 618a of the user of the electronic device 500a because the user of the electronic device 500a edited the shared document 606. In some embodiments, the indication 614a includes an indication 618b of the name of the user that edited the shared document 606 and the name of the shared document 606. In some embodiments, the indication 614a includes a selectable option 618c that, when selected, causes the second electronic device 500b to display the shared document 606. In some embodiments, in response to detecting selection of selectable option 618c, the second electronic device 500b displays a portion of the shared document 606 that includes the revisions made by the user of the electronic device 500a. In some embodiments, the indication 614a further includes a selectable option 618d that, when selected, causes the second electronic device 500b to cease display of the indication 614a and continue to display the messaging conversation in the user interface 610.

In FIG. 6C, the second electronic device 500b receives an input (e.g., including contact 603c) selecting the option 612b to display the user interface for changing one or more settings for the messaging conversation. In response to the input illustrated in FIG. 6C, the electronic device 500b displays the messaging conversation settings user interface shown in FIG. 6D.

FIG. 6D illustrates the second electronic device 500b displaying the messaging conversation settings user interface in response to the input illustrated in FIG. 6C. In some embodiments, the settings user interface includes an image 620b associated with the messaging conversation, options 622a-c for contacting the users in the messaging conversation, indications 624b-c of the users in the conversations, an option 624d that, when selected, causes the electronic device 500b to initiate a process to add another user to the messaging conversation, and an option 620d that, when selected, causes the electronic device 500b to navigate back to the user interface illustrated in FIG. 6C. In some embodiments, in response to detecting selection of option 622a, the second electronic device 500b initiates a phone call with the other users in the messaging conversation. In some embodiments, in response to detecting selection of option 622b, the second electronic device 500b initiates a videoconference with the other users in the messaging conversation. In some embodiments, in response to detecting selection of option 622c, the second electronic device 500b initiates an e-mail with the other users in the messaging conversation. In some embodiments, in response to detecting selection of option 624b or 624c, the electronic device 500b displays a contact card user interface for the user associated with option 624b or 624c, respectively.

In some embodiments, in FIG. 6D, the second electronic device 500b receives an input (e.g., including contact 603d) selecting the option 624d to add another user to the messaging conversation. In some embodiments, in response to the input illustrated in FIG. 6D, the second electronic device 500b displays a user interface for selecting the user to add to the messaging conversation. In response to sequence of inputs including the input illustrated in FIG. 6D, the electronic device 500b adds another user to the messaging conversation and updates the settings user interface to indicate the user that was added to the messaging conversation, as shown in FIG. 6E.

FIG. 6E illustrates the second electronic device 500b displaying the settings user interface updated in response to adding the additional user to the messaging conversation in response to the sequence of inputs including the input illustrated in FIG. 6D. In some embodiments, as described in more detail below with reference to method 900, adding the user to the messaging conversation does not add the user to the shared document. As shown in FIG. 6E, for example, the second electronic device 500b includes the indication 624e of the user added to the messaging conversation and displays an updated image 620c representing the messaging conversation. As shown in FIG. 6E, the electronic device 500b receives an input (e.g., including contact 603c) selecting the option 620a to display the messaging conversation, as shown in FIG. 6F.

FIG. 6F illustrates the second electronic device 500b displaying the messaging conversation after adding a user to the messaging conversation in response to the input illustrated in FIG. 6E. As shown in FIG. 6F, the electronic device 500b displays an indication 614c of the user that was added to the messaging conversation overlaid on the messaging conversation because the user was added to the messaging conversation, but not to the shared document. In some embodiments, the indication 614c includes an indication 618f of the name of the user added to the conversation and the name of the shared document shared with the messaging conversation, but not with the additional user yet. In some embodiments, the indication 614c further includes an option 618g that, when selected, causes the electronic device 500b to add the user to the shared document. In some embodiments, the indication 614c further includes an option 618d to cease display of the indication 614c and maintain display of the messaging conversation. In some embodiments, as described below with reference to method 900, the electronic device 500b displays other indications in response to discrepancies in the users that have access to the shared document and the messaging conversation, for example, when a user is added or removed from the shared document or the messaging conversation without being added or removed from both the shared document and the messaging conversation.

In some embodiments, in response to receiving an additional message to the messaging conversation, the electronic device 500b ceases display of the indication 614c. For example, in FIG. 6F, the electronic device 500b receives an indication 626 of a message being added to the messaging conversation. In response to receiving the indication 626 of the message in FIG. 6F, the second electronic device 500b ceases display of the indication 614c and maintains display of the messaging conversation, as shown in FIG. 6G.

In some embodiments, as shown in FIG. 6G, the second electronic device 500b displays the messaging conversation without displaying the indication 614c that was displayed in FIG. 6F. As shown in FIG. 6F, in addition to ceasing display of the indication 614c, the electronic device 500b displays an indication 616c of the message that was received in FIG. 6F.

FIG. 7 is a flowchart illustrating an exemplary method 700 of presenting indications of changes to a shared document and/or to the users in a messaging conversation while displaying the messaging conversation in accordance with some embodiments of the disclosure. The method 700 is optionally performed at an electronic device such as device 100, device 300, device 500, device 501, device 510, and device 591 as described above with reference to FIGS. 1A-1B, 2-3, 4A-4B and 5A-5I. Some operations in method 700 are, optionally combined and/or order of some operations is, optionally, changed.

As described below, the method 700 provides ways for interaction with messaging conversations and/or shared documents. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device (e.g., 500a) in communication with a display generation component, such as in FIG. 6A. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), a device integrated with a vehicle (e.g., an infotainment system) and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users.

In some embodiments, such as in FIG. 6C, the electronic device (e.g., 500b) displays (702), via the display generation component (e.g., 504b), a messaging conversation in a messaging user interface (e.g., 610) between two or more users that have access to a shared document. In some embodiments, the messaging conversation includes one or more indications of messages included in the conversation. In some embodiments, messages included in the conversation are accessible to the two or more users in the messaging conversation. In some embodiments, the indications of messages include a visual indication of a user that sent the message. In some embodiments, messages include text, still or video image(s), audio content, hyperlinks to web sites, and/or rich messages associated with the shared document. In some embodiments, a shared document is a file or document accessible to the two or more users using an application different from the messaging application that includes the messaging conversation. For example, the electronic device displays the shared document in a word processing application. In some embodiments, the two or more users are able to access the shared document, including revisions made to the document after access to the document by the two or more users was granted. In some embodiments, the two or more users have permission to make changes to the shared document. In some embodiments, some, but not all, of the two or more users have permission to make changes to the shared document. In some embodiments, the messaging conversation is concurrently displayed with the shared document. In some embodiments, the electronic device displays the messaging conversation without displaying the shared document. In some embodiments, the users that have access to the shared document are able to access the shared document from a plurality of electronic devices associated with their user account. In some embodiments, the messaging conversation and/or shared document have one or more features in common with the messaging conversation and/or shared document described below with reference to method(s) 900 and/or 1100.

In some embodiments, such as in FIG. 6B, while displaying the messaging conversation (704), the electronic device (e.g., 500b) detects (706) an indication of a change to the shared document (e.g., 606) or the two or more users. In some embodiments, the change is one of the two or more users revising the shared document. In some embodiments, the change is adding or removing a user from the two or more users with access to the messaging conversation and/or the shared document. In some embodiments, the change is adding or removing a user from the two or more users with access to the shared document. In some embodiments, when a user is removed from having access to one of the shared document or the messaging conversation, but not both, the electronic device presents user interfaces for resolving the discrepancy between participants in the messaging conversation and those with access to the shared document according to one or more steps of method 900. In some embodiments, the change is adding or removing a user from the two or more users with access to the messaging conversation and the shared document.

In some embodiments, while displaying the messaging conversation (704), in response to detecting the indication of the change (708), in accordance with a determination that the change is a first change, the electronic device (e.g., 500b) displays (710), via the display generation component, a first visual indication (e.g., 614a) that indicates the first change in the messaging user interface (e.g., 610), such as in FIG. 6B. In some embodiments, the first visual indication includes an indication of the change that occurred and the user that caused the change. For example, if the change is a first user editing the shared document, the first visual indication includes an indication that the shared document was revised by the first user. In some embodiments, the first visual indication is displayed in the messaging user interface in line (e.g. chronologically) with indications of messages in the messaging conversation. In some embodiments, the first visual indication is displayed overlaid on indications of messages in the messaging conversation. In some embodiments, the first visual indication is displayed at a predetermined location in the messaging conversation irrespective of a temporal relationship between the first change and one or more messages in the messaging conversation. In some embodiments, the first visual indication is displayed at a location in the messaging conversation in accordance with a temporal relationship between the first change and the one or more messages in the messaging conversation.

In some embodiments, while displaying the messaging conversation (704), in response to detecting the indication of the change (708), in accordance with a determination that the change is a second change, the electronic device (e.g., 500b) displays (712), via the display generation component (e.g., 504b), a second visual indication (e.g., 614c), different from the first visual indication, that indicates the second change in the messaging user interface (e.g., 610), such as in FIG. 6F. In some embodiments, the second visual indication includes an indication of the change that occurred and the user that caused the change. For example, if the change is a first user sharing the document with a second user that did not previously have access to the shared document, the second visual indication includes an indication that the first user shared the document with the second user (e.g., thus adding the second user to the two or more users that have access to the shared document and/or the messaging conversation). In some embodiments, the second visual indication is displayed in the messaging user interface in line (e.g., chronologically) with indications of messages in the messaging conversation. In some embodiments, the second visual indication is displayed overlaid on indications of messages in the messaging conversation. In some embodiments, the second visual indication is displayed at a predetermined location in the messaging conversation irrespective of a temporal relationship between the first change and one or more messages in the messaging conversation at the same predetermined location at which the first visual indication would be displayed. In some embodiments, the second visual indication is displayed at a location in the messaging conversation in accordance with a temporal relationship between the first change and the one or more messages in the messaging conversation.

Presenting indications of changes to the shared document and/or to the two or more users in the messaging user interface that includes the messaging conversation enhances interactions with the electronic device by reducing the number of inputs needed to view a messaging conversation related to a shared document that has been changed.

In some embodiments, while displaying, via the display generation component (e.g., 504b), the messaging conversation in the messaging user interface (e.g., 610), the electronic device (e.g., 500b) receives an indication (e.g., 626) of a message added to the messaging conversation. In some embodiments, the message is sent by another one of the two or more users that have access to the messaging conversation and shared document.

In some embodiments, in response to receiving the indication of the message, the electronic device (e.g., 500b) displays a representation (e.g., 616c) of the message in the messaging conversation that is different from the first visual indication or the second visual indication, such as in FIG. 6G. In some embodiments, in response to receiving a message in the messaging conversation, the electronic device displays a representation of the message that includes the contents of the message in the messaging conversation. In some embodiments, the representation of the message is different from the first or second visual indications. For example, the representation of the message is displayed at a different location in the user interface than the first and/or second visual indications and/or has a different appearance than the first and/or second visual indications. Displaying a representation of the message different from the first and/or second visual indications enhances user interactions with the electronic device by providing improved visual feedback to the user, thereby enabling the user to use the electronic device quickly and efficiently.

In some embodiments, such as in FIG. 6B, in accordance with the determination that the change is the first change, the first change is a change to the shared document, and the first change is associated with a first user, a first type of change, and a first timestamp, the first visual indication (e.g., 614a) includes an indication of a name of the first user (e.g., 618b), an indication of the first type of change (e.g., 618b), an indication of the first timestamp (e.g., 618b), and a selectable option (e.g., 618c) that, when selected, causes the electronic device (e.g., 500b) to display the shared document (and cease display of the first visual indication and the messaging conversation). In some embodiments, the first visual indication further includes a second selectable option that, when selected, causes the electronic device to cease display of the first visual indication and maintain display of the messaging conversation. In some embodiments, the indication of the first type of change indicates the first type of change without indicating the contents of the change. For example, if the first type of change is editing the shared document, the indication is text that reads “edited” the shared document without including an indication of the edits made to the shared document. In some embodiments, the first visual indication further includes an image associated with the first user that made the change, such as an image included in the contact card for the first user.

In some embodiments, in accordance with the determination that the change is the second change, the second change is a change to the shared document, and the second change is associated with a second user, a second type of change, and a second timestamp, the second visual indication includes an indication of a name of the second user, an indication of the second type of change, an indication of the second timestamp, and the selectable option that, when selected, causes the electronic device to display the shared document (and cease display of the messaging conversation and the second visual indication), similar to how indication 614b in FIG. 6C includes an indication 618e of the type of change and second time stamp and the selectable option 618c that, when selected, causes the electronic device (e.g., 500b) to display the shared document. In some embodiments, the second visual indication further includes a second selectable option that, when selected, causes the electronic device to cease display of the second visual indication and maintain display of the messaging conversation. In some embodiments, the indication of the second type of change indicates the second type of change without indicating the contents of the change. For example, if the second type of change is editing the shared document, the indication is text that reads “edited” the shared document without including an indication of the edits made to the shared document. In some embodiments, the second visual indication further includes an image associated with the second user that made the change, such as an image included in the contact card for the second user. Displaying indications of the user, type of change, timestamp, and an option to display the shared document in the visual indication of the change enhances user interactions with the electronic device by providing improved visual feedback to the user.

In some embodiments, while displaying, via the display generation component (e.g., 504b), the messaging conversation in the messaging user interface (e.g., 610), such as in FIG. 6B, the electronic device (e.g., 500b) receives, via the one or more input devices, an input selecting the selectable option (e.g., 618c). In some embodiments, in accordance with the determination that the change is the first change, the selectable option is included in the first visual indication. In some embodiments, in accordance with the determination that the change is the second change, the selectable option is included in the second visual indication.

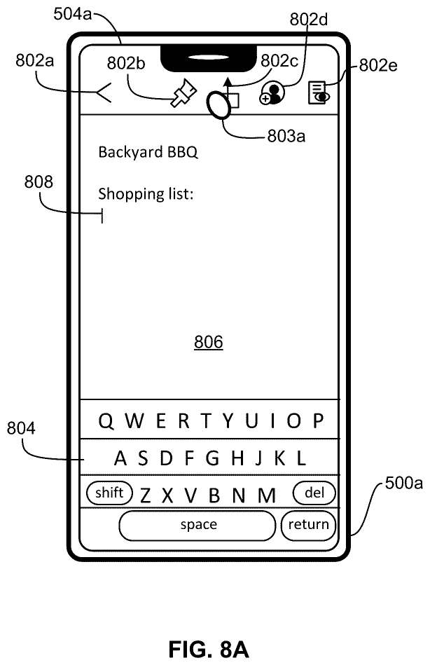

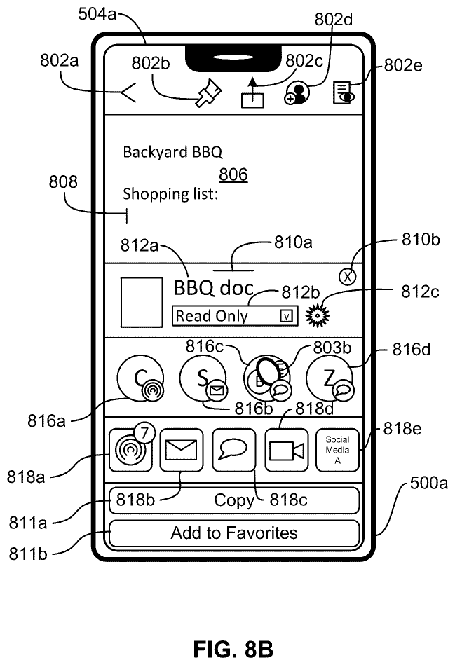

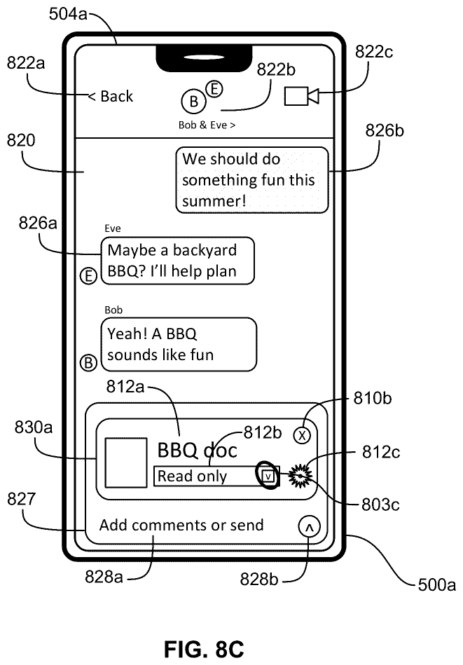

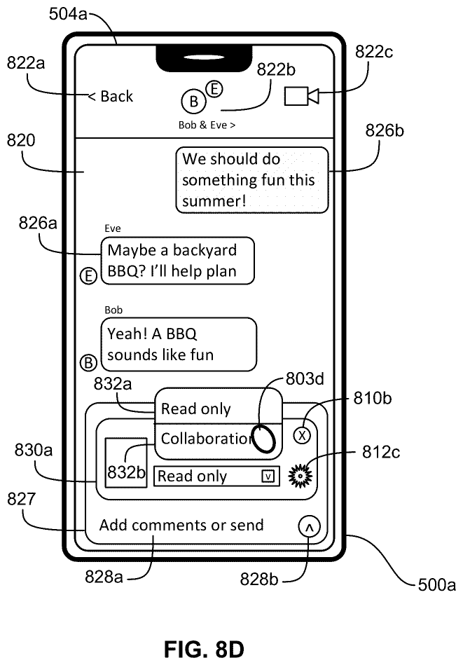

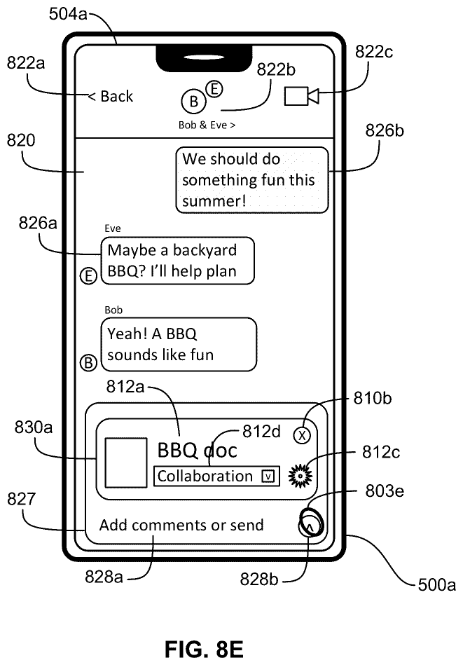

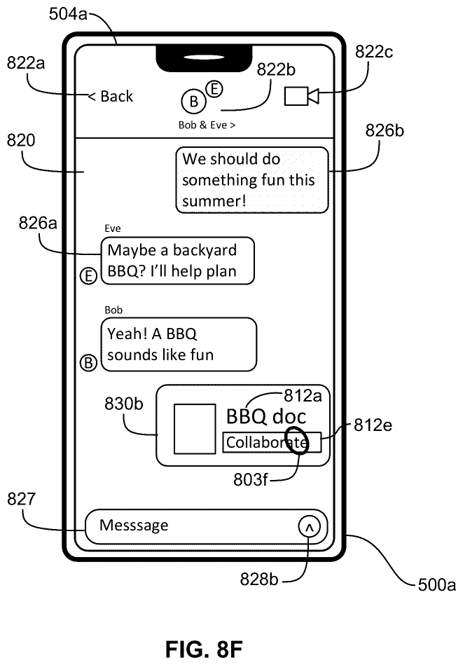

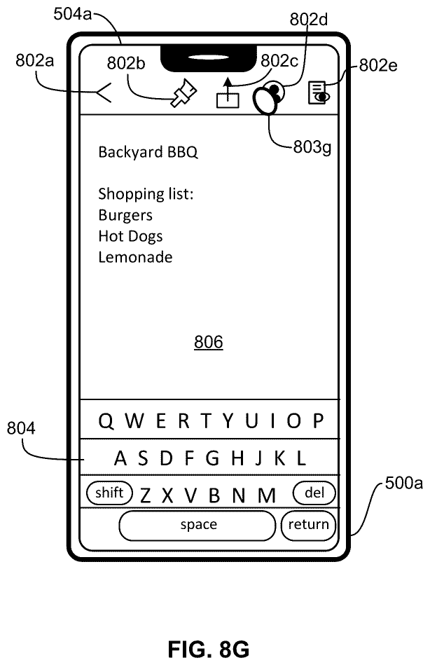

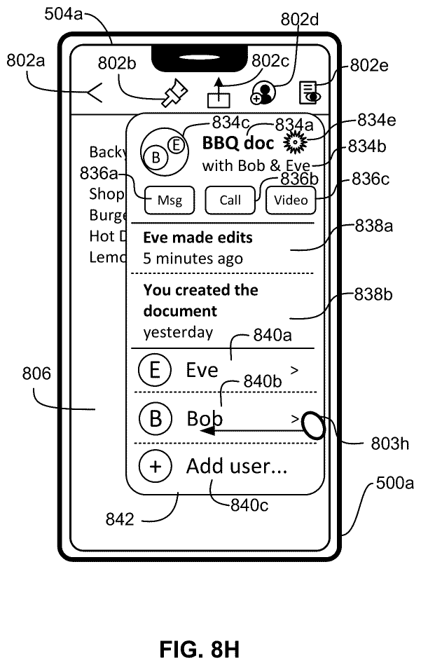

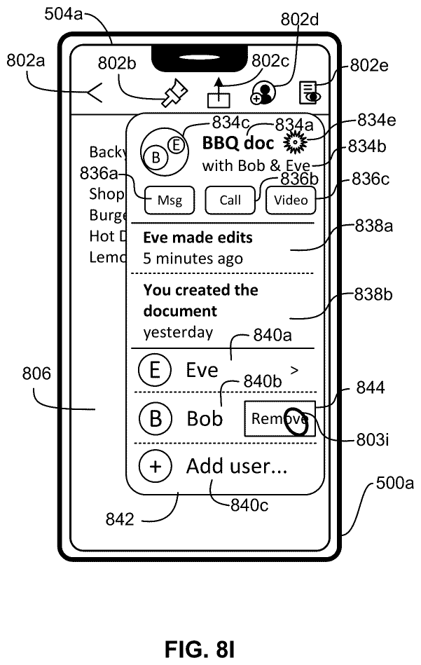

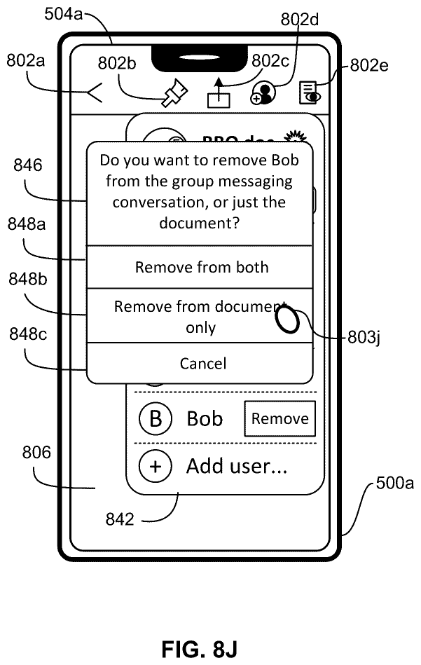

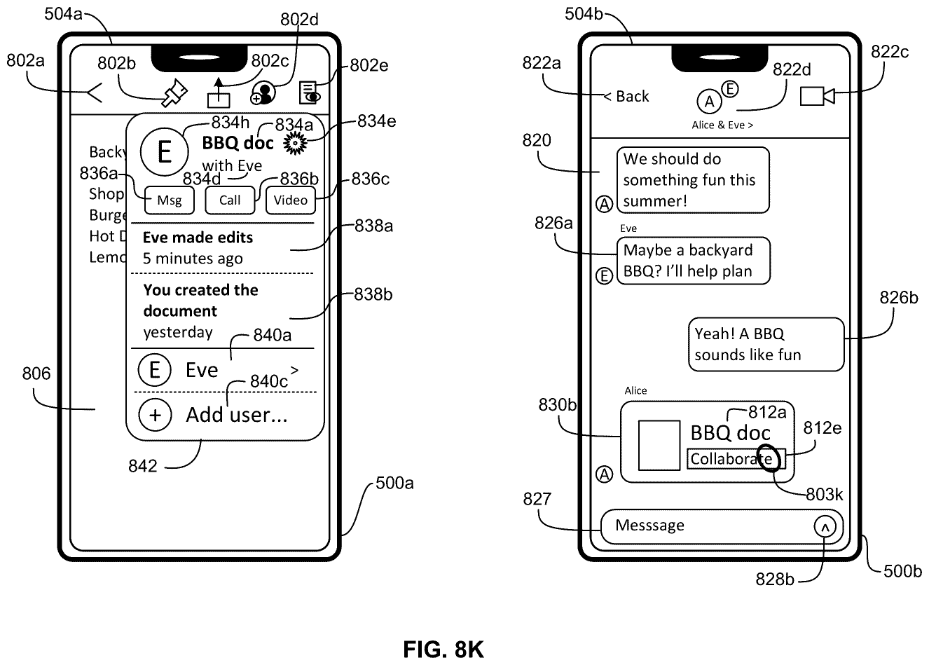

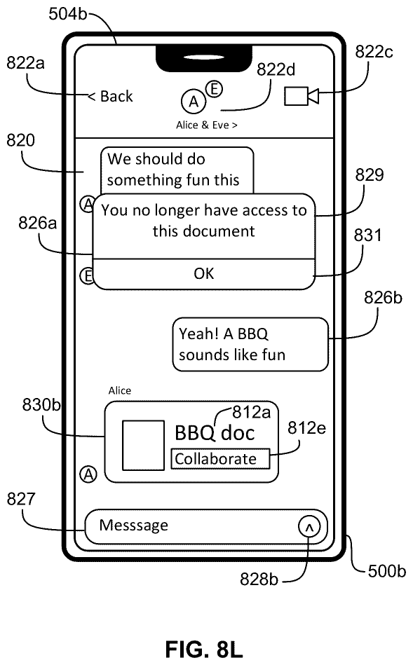

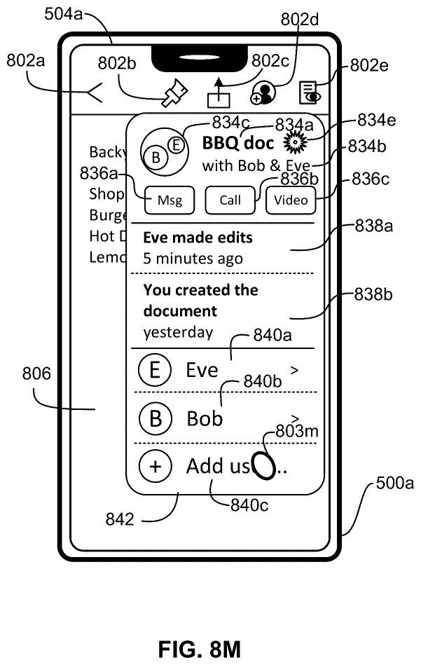

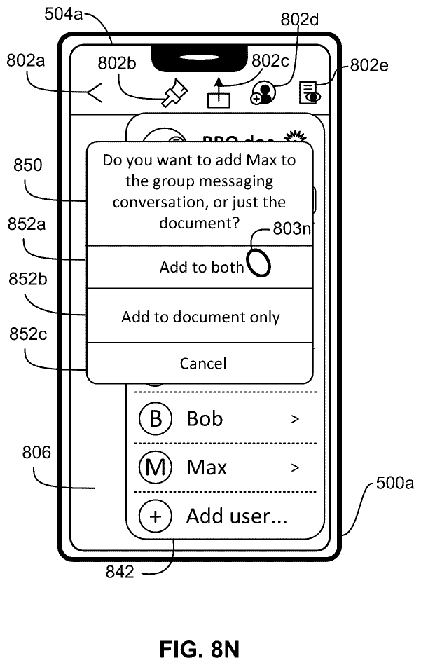

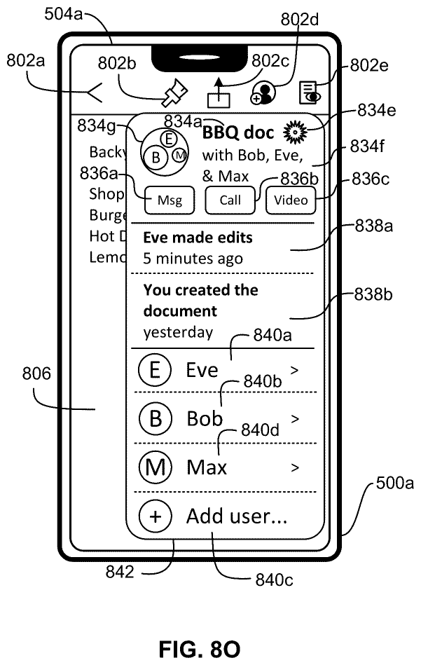

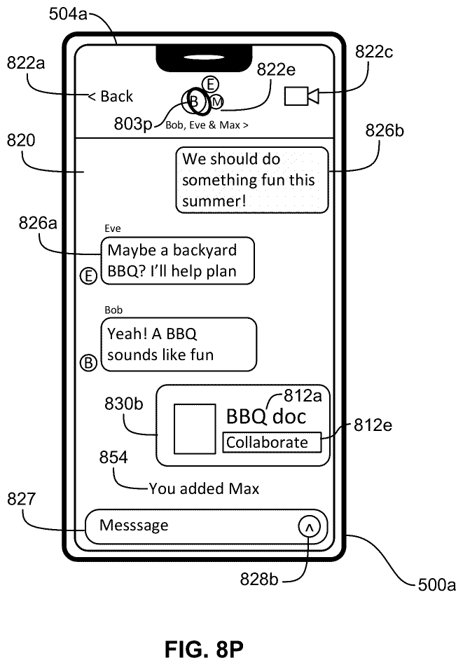

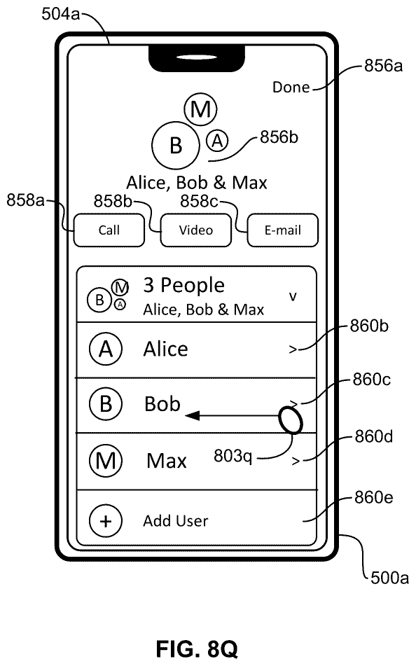

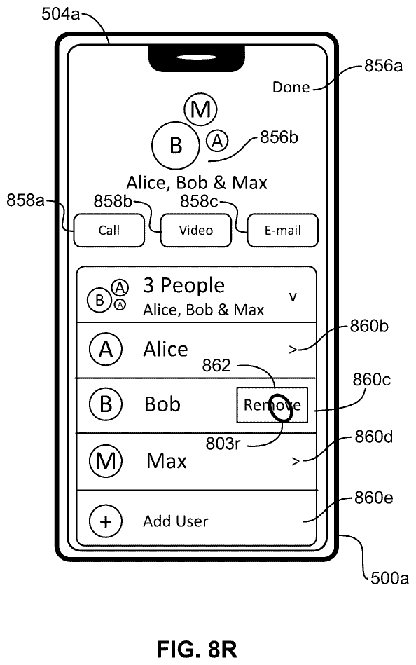

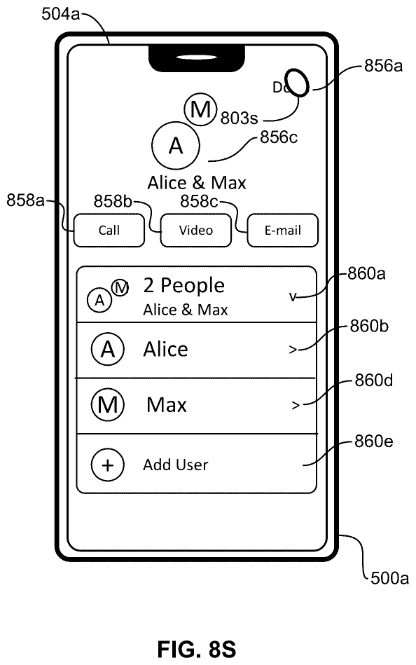

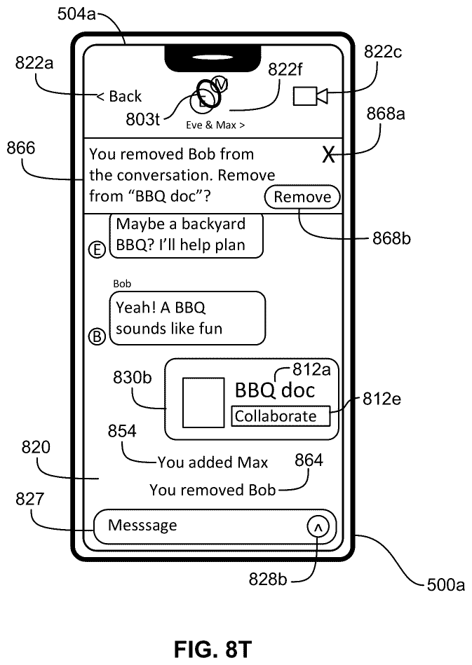

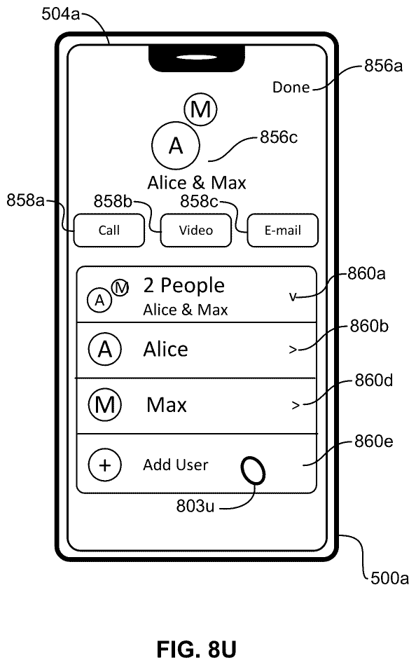

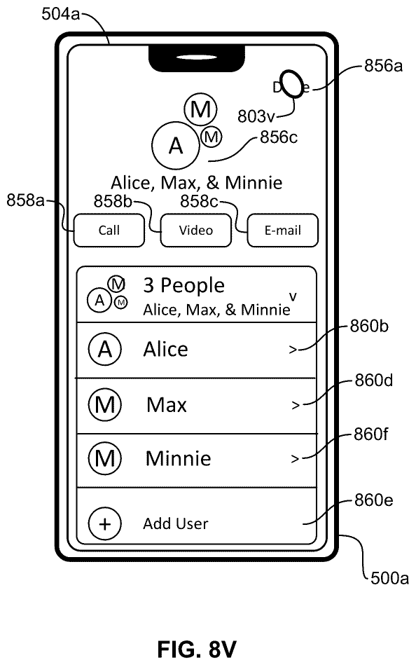

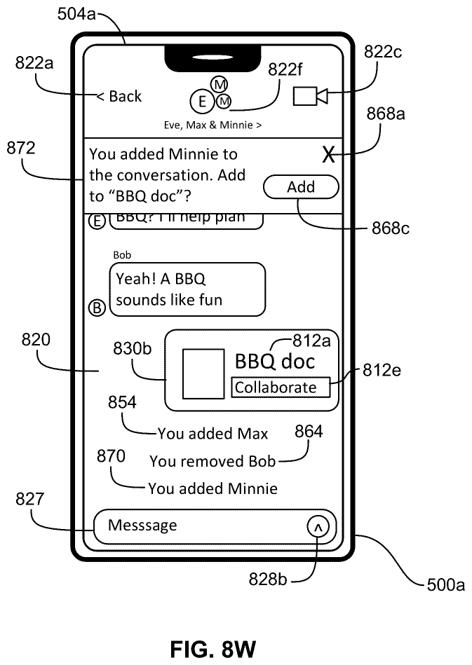

In some embodiments, the messaging user interface (e.g., 610) includes, in accordance with the determination that the change is the first change, the first visual indication (e.g., 614a) that indicates the first change, such as in FIG. 8B. In some embodiments, the messaging user interface (e.g., 610) includes in accordance with the determination that the change is the second change, the second visual indication (e.g., 618d) that indicates the second change.

In some embodiments, in response to receiving the input selecting the selectable option (e.g., 618c in FIG. 6B), in accordance with the determination that the change is the first change, the electronic device (e.g., 500b), via the display generation component (e.g., 504b), a portion of the shared document including the first change (and ceasing display of the messaging conversation and first visual indication). In some embodiments, in response to receiving the input selecting the selectable option, in accordance with the determination that the change is the first change, the electronic device displays the shared document scrolled to a portion of the document that includes the first change. In some embodiments, the electronic device displays the portion of the document that includes the first change with a visual indication, such as highlighting or a box around the first change in the shared document and displays a second portion of the document that does not include the change without the visual indication.

In some embodiments, in response to receiving the input selecting the selectable option (e.g., 618c in FIG. 6C), in accordance with the determination that the change is the second change, the electronic device (e.g., 500b) displays, via the display generation component (e.g., 504b), a portion of the shared document including the second change (and ceasing display of the messaging conversation and second visual indication). In some embodiments, in response to receiving the input selecting the selectable option, in accordance with the determination that the change is the second change, the electronic device displays the shared document scrolled to a portion of the document that includes the second change. In some embodiments, the electronic device displays the portion of the document that includes the second change with a visual indication, such as highlighting or a box around the second change in the shared document and displays a second portion of the document that does not include the change without the visual indication. Displaying the portion of the shared document including the change in response to detecting selection of the selectable option enhances user interactions with the electronic device by reducing the number of inputs needed to review the change to the shared document.

In some embodiments, while displaying the messaging conversation, the electronic device (e.g., 500b) detects an indication of a plurality of changes to the shared document or the two or more users, such as in FIG. 6C. In some embodiments, the plurality of changes are changes to the shared document without changes to the two or more users. In some embodiments, the plurality of changes are to the two or more users without changes to the shared document. In some embodiments, the plurality of changes include changes to the shared document and to the two or more users.

In some embodiments, while displaying the messaging conversation, in response to detecting the indication of the plurality of changes, the electronic device (e.g., 500b) displays, via the display generation component (e.g., 504b), a third visual indication (e.g., 614b) that indicates the plurality of changes in the messaging user interface (e.g., 610). In some embodiments, the third visual indication indicates the number of users that made changes to the shared document without listing the names of the users that made changes to the shared document. In some embodiments, the third visual indication indicates the number of users that made changes to the two or more users without listing the names of the users that made changes to the two or more users. In some embodiments, in response to detecting an indication of a respective change to the shared document or the two or more users while the first or second visual indication is displayed in the user interface, the electronic device updates the user interface to cease display of the first or second visual indication and display the third visual indication, rather than displaying multiple visual indications of the changes. Displaying the third visual indication in response to detecting the indication of the plurality of changes enhances user interactions with the electronic device by displaying additional information without cluttering the user interface with additional displayed indications.

In some embodiments, such as in FIG. 6B, the change is an edit made to the shared document. In some embodiments, the first or second indication includes an indication that an edit was made to the shared document without including an indication of the contents of the edit. Displaying an indication that an edit was made to the shared document enhances user interactions with the electronic device by providing improved visual feedback to the user.

In some embodiments, such as in FIG. 6F, the change is one of adding or removing a respective user of the two or more users to the messaging conversation. In some embodiments, the respective indication includes an indication of the user that made the change and/or an indication of the user that was added or removed from the two or more users in the messaging conversation. In some embodiments, in response to receiving one or more inputs adding or removing a user from the messaging conversation, the electronic device displays a selectable option that, when selected, causes the electronic device to add or remove the user from the shared document according to one or more steps of method 900. Displaying an indication that a user was added or removed from the two or more users with access to the messaging conversation enhances user interactions with the electronic device by providing improved visual feedback to the user.

In some embodiments, while displaying the messaging conversation, the electronic device (e.g., 500b) detects an indication of a plurality of changes to the shared document made by a plurality of users, such as in FIG. 6C. In some embodiments, the plurality of changes to the shared document are edits to the contents of the shared document. In some embodiments, the plurality of changes are the same as each other. In some embodiments, the plurality of changes are the same type of change (e.g., edit to the document, adding/removing a user from the messaging conversation) but the contents of the changes (e.g., the particular changes made to the document, the particular users added and/or removed from the messaging conversation) are different.

In some embodiments, while displaying the messaging conversation, in response to detecting the indication of the plurality of changes to the shared document made by the plurality of users, the electronic device (e.g., 500b) displays, via the display generation component (e.g., 504b), a third visual indication (e.g., 618d) of the plurality of changes to the shared document made by the plurality of users that indicates a number of users in the plurality of users in the messaging user interface (e.g., 610). In some embodiments, the third visual indication does not include contents of the edits to the shared document and includes an indication the document was edited by the number of users. In some embodiments, in response to detecting a change made to the shared document while displaying the first or second indication indicating a first change made to the shared document, the electronic device ceases display of the first or second indication and displays the third indication with the messaging conversation. Displaying the third visual indication in response to detecting the indication of the plurality of changes enhances user interactions with the electronic device by displaying additional information without cluttering the user interface with additional displayed indications.

In some embodiments, such as in FIG. 6C, the plurality of users have a plurality of names, and the third visual indication (e.g., 614b) does not include (any of) the plurality of names of the plurality of users. In some embodiments, the third visual indication does not include images associated with (any of) the plurality of users (e.g., images included in the contact cards of the plurality of users). Displaying the third visual indication without the names of the plurality of users enhances user interactions with the electronic device by displaying additional information without cluttering the user interface with additional displayed indications.

In some embodiments, the change is adding a respective user that does not have access to the shared document or the messaging conversation to the messaging conversation, such as in FIG. 6F.

In some embodiments, such as in FIG. 6F, in response to detecting the indication of the change, the electronic device (e.g., 500b) displays, via the display generation component (e.g., 504b), a third visual indication (e.g., 618d) of the change in the messaging user interface (e.g., 610), the third visual indication including a selectable option (e.g., 618g) that, when selected, causes the electronic device (e.g., 500b) to add the respective user to the shared document. In some embodiments, the third visual indication includes the name of the user that was added to the messaging conversation. In some embodiments, the third visual indication has one or more characteristics described below with reference to method 900, such as a selectable option that, when selected, causes the electronic device to initiate a process to add the respective user to the shared document. Displaying the third visual indication in response to detecting a respective user added to the messaging conversation enhances user interactions with the electronic device by reducing the inputs and time needed to add the respective user to the shared document in addition to the messaging conversation.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method(s) 900 and/or 1100) are also applicable in an analogous manner to method 700 described above with respect to FIG. 7. For example, the operation of the electronic device displaying indications of changes to the shared document and/or the users with access to the messaging conversation described above with reference to method 700 optionally has one or more of the characteristics of presenting options to update the users with access to shared documents and/or messaging conversations and/or participating in communication sessions associated with a shared document described herein with reference to other methods described herein (e.g., method(s) 900 and/or 1100). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 7 are, optionally, implemented by components depicted in FIGS. 1A-1B. For example, displaying operations 702, 710, and/or 712 and/or detecting operation 706 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Managing User Access to Shared Documents and Messaging Conversations

Users interact with electronic devices in many different manners. In some embodiments, an electronic device accesses a shared document accessible by one or more other users and a messaging conversation accessible to one or more other users. The embodiments described below provide ways in which an electronic device displays options to update the users with access to the messaging conversation or the shared document in response to a change in access to the other of the messaging conversation or the shared document. For example, the electronic device displays an option to add or remove a user from the shared document in response to the user being added or removed from the messaging conversation, and vice versa. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

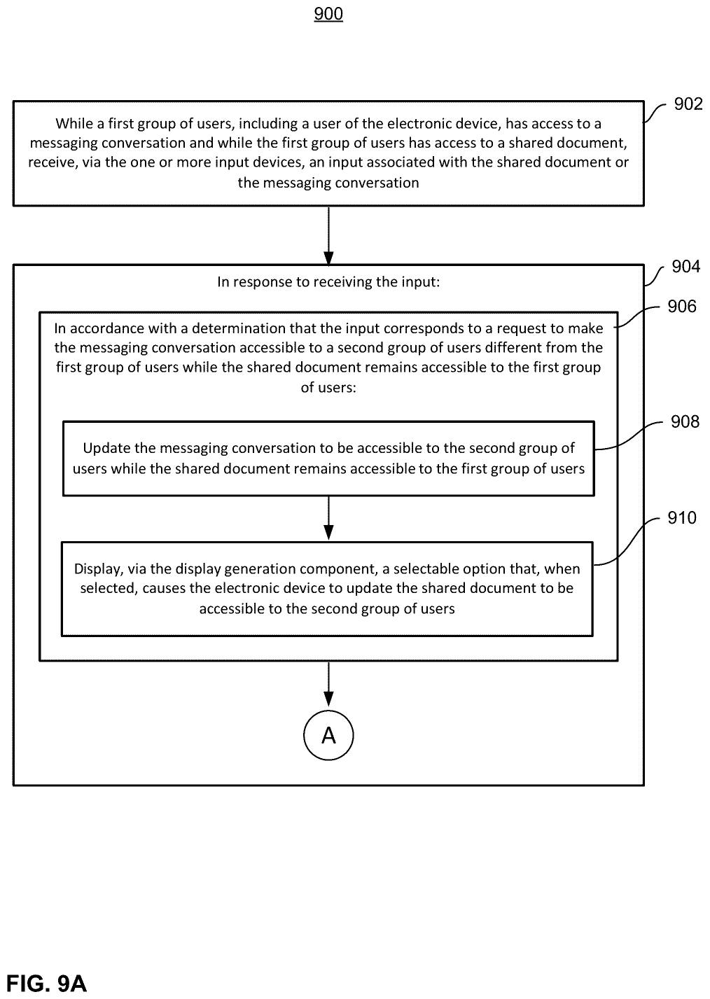

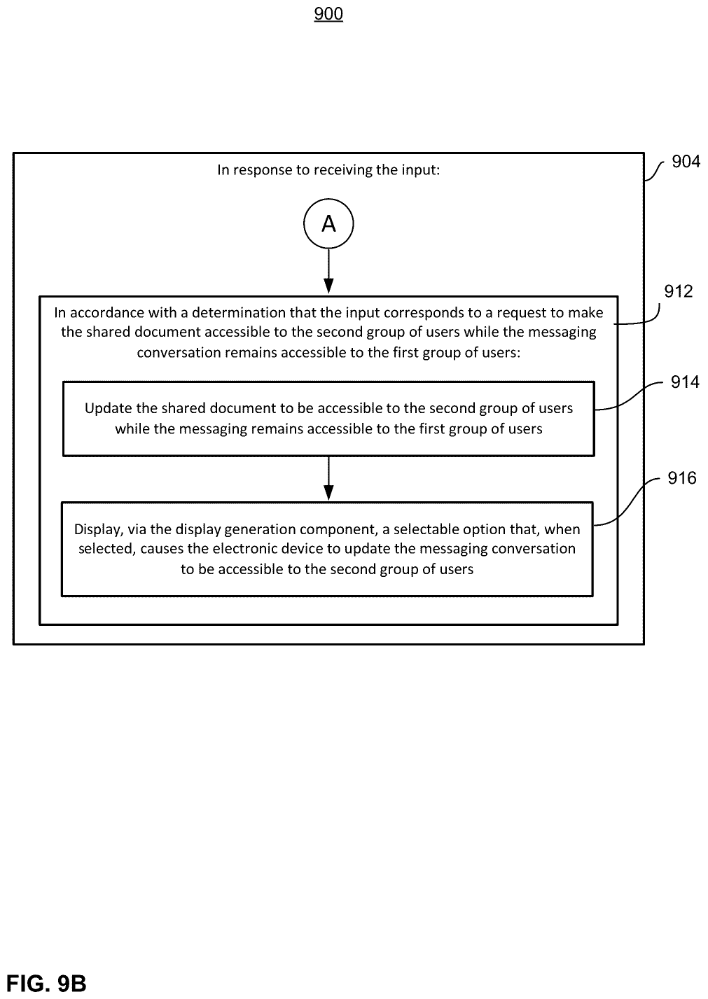

FIGS. 8A-8W illustrate exemplary ways of presenting options to update the users with access to shared documents and/or messaging conversations in accordance with some embodiments of the disclosure. The embodiments in these figures are used to illustrate the processes described below, including the processes described with reference to FIGS. 9A-9B.

FIG. 8A illustrates an example of the electronic device 500a displaying a document 806 in a user interface of a document editing and/or viewing application. In some embodiments, the document 806 is not accessible to other users while the electronic device 500a displays the document 806 in FIG. 8A. In some embodiments, the user interface includes back option 802a, formatting option 802b, share option 802c, collaboration option 802d, proofreading option 802e, and soft keyboard 804 described in more detail above with reference to method 700. As shown in FIG. 8A, the electronic device 500a receives an input (e.g., including contact 803a) selecting the share option 802c. In response to the input in FIG. 8A, the electronic device 500a displays the sharing user interface shown in FIG. 8B.

FIG. 8B illustrates the electronic device 500a displaying a sharing user interface associated with the document 806 in response to the input illustrated in FIG. 8A. The sharing user interface includes an indication 812a of the name of the document 806, an option 812b to change the a setting for allowing other users to view the document 806 without editing the document 806 or allowing other users to view and edit the document 806, an option 812c to display additional sharing options, options 816a-816d for sharing the document with respective users or respective groups of users via respective communication methods, options 818a-e for sharing the document 806 using respective communication methods, an option 811a to copy the shared document 806, an option 811b to add the document 806 to a list of favorite documents, a user interface element 810a for adjusting the size of the sharing user interface, and an option 810b to close the sharing user interface without sharing the document 806.

In some embodiments, options 816a-816d are associated with respective users or groups of users and respective communication methods, whereas options 818a-818e are associated with respective communication methods without being associated with respective users in particular. For example, in response to detecting selection of one of options 816a-816d, the electronic device 500a initiates a process to share the document 806 with the user indicated by the selected option using the communication method indicated by the respective option. As another example, in response to detecting selection of one of options 818a-818e, the electronic device 500a initiates a process to share the document 806 using the communication method identified by the selected option and displays a user interface that enables the user of electronic device 500a to select the user(s) with which to share the document using the communication method.

In FIG. 8B, the electronic device 500a receives an input (e.g., including contact 803b) selecting an option 816c to share the document 806 with a respective messaging conversation in a messaging application. In some embodiments, in response to the input illustrated in FIG. 8B, the electronic device 500a displays the messaging user interface illustrated in FIG. 8C.

FIG. 8C illustrates the electronic device 500a displaying a messaging user interface for sharing the document in response to the input detected in FIG. 8B. In some embodiments, the messaging user interface in FIG. 8C includes the messaging conversation corresponding to the option selected in FIG. 8B. The messaging user interface in FIG. 8C includes back option 822a, conversation settings option 822b, videoconferencing option 822c, indications 826a-b of messages, a message composition field 827, and an option 828b to send the message shown in message composition field 827 described above with reference to method 700.

As shown in FIG. 8C, in some embodiments, the messaging user interface includes an indication 830a of a message sharing the document in the message composition field 827 because the electronic device 500a displayed the messaging conversation in response to an input to share the document with the messaging conversation in the messaging user interface. The indication 830a of the message sharing the document includes an indication 812a of the name of the document, an option 812b to view settings for sharing the document with editing permission or with permission to view the document without editing, an option 812c to change additional settings for sharing the document, and an option 810b to cease display of the indication 830a of the message sharing the document in the messaging user interface and maintain display of the messaging conversation.

In some embodiments, in response to detecting selection of the option 828b to send the message in the message composition field 827 while displaying the indication 830a of the message to share the document, the electronic device 500a shares the document with the currently-selected sharing settings, including sharing the document as a read-only document without allowing the other users to edit the document. In some embodiments, in response to receiving selection of option 812b or 812c followed by receiving one or more inputs to change settings for sharing the document, the electronic device 500a changes the settings for sharing the document. In some embodiments, in response to detecting selection of the option 828b to send the message after detecting the inputs to change the settings for sharing the document, the electronic device 500a sends the message sharing the document with the settings updated in response to the inputs.

For example, as shown in FIG. 8C, the electronic device 500a receives an input (e.g., including contact 803c) selecting the option 812b to view the options for changing the editing permissions of the document. In response to the input illustrated in FIG. 8C, the electronic device 500a displays the options shown in FIG. 8D.

FIG. 8D shows the electronic device 500a displaying the messaging user interface updated in response to the input shown in FIG. 8C. In some embodiments, in response to the input in FIG. 8C, the electronic device 500a displays options 832a and 832b in the messaging user interface, as shown in FIG. 8D. For example, option 832a is an option to share the document with read-only permissions that enables the other users to view the document without making edits to the document and option 832b is an option to share the document with editing permissions that enable the users to view and edit the document. As shown in FIG. 8D, the electronic device 500a detects an input (e.g., including contact 803d) selecting the option 832b to share the document with editing permissions. In response to the input illustrated in FIG. 8D, the electronic device 500a updates the indication 830a of the message to indicate that the document will be shared with editing permissions, as shown in FIG. 8E.

FIG. 8E illustrates the electronic device 500a displaying the indication 830a of the message updated in response to the input illustrated in FIG. 8D. As shown in FIG. 8E, the indication 830a of the message to share the document includes an indication 812d that the document will be shared with editing permissions that allow the other users to view and make edits to the shared document. In some embodiments, the electronic device 500a receives an input (e.g., including contact 803c) selecting the option 828b to send the message sharing the document to the messaging conversation with editing permissions. In response to the input illustrated in FIG. 8E, the electronic device updates the messaging user interface to show that the message sharing the document has been sent, as shown in FIG. 8F.

FIG. 8F illustrates the electronic device 500a displaying the updated messaging user interface that includes the message 830b sharing the shared document. As shown in FIG. 8F, the message 830b sharing the shared document includes an indication 812a of the title of shared document and an option 812e that, when selected, causes the electronic device 500a to view the shared document. In some embodiments, the option 812e says “Collaborate” because the document is shared with editing permissions. In some embodiments, if the document had been shared with viewing permissions without editing permissions, the option 812e would say “view” or “read” instead of “collaborate.” As shown in FIG. 8F, the electronic device 500a receives an input selecting option 812e the option to view the shared document. In some embodiments, in response to the input illustrated in FIG. 8F, the electronic device 500a ceases display of the messaging user interface and displays the shared document, as shown in FIG. 8G.

FIG. 8G illustrates the electronic device 500a displaying the shared document 806 in response to the input illustrated in FIG. 8F. In FIG. 8F, the electronic device 500a receives an input (e.g., including contact 803g) selecting the collaboration menu option 802d. In response to the input illustrated in FIG. 8G, the electronic device 500a displays the collaboration menu overlaid on the shared document 806, as shown in FIG. 8H.

FIG. 8H illustrates the electronic device 500a displaying the collaboration menu 842 overlaid on the shared document 806. In some embodiments, the collaboration menu 842 includes an image 834c associated with the messaging conversation with which the document 806 is shared, an indication 834a of the title of the shared document 806, an indication 834b of the messaging conversation with which the document 806 is shared, an option 834e to view additional settings related to the document, options 836a-836c to contact the users with whom the document is shared, indications 838a and 838b of previous revisions made to the document, indications 840a and 804b of users with whom the document 806 is shared, and an option 8340c to share the document 806 with an additional user.

In some embodiments, the image 834c associated with the messaging conversation is an image selected in the settings user interface associated with the messaging conversation. In some embodiments, as shown in FIG. 8H, the image 834c includes images associated with the users in the messaging conversation. In some embodiments, the name of the messaging conversation included in indication 834b is a name chosen in the settings user interface associated with the messaging conversation. In some embodiments, as shown in FIG. 8H, the name of the messaging conversation includes the names of the other users in the messaging conversation.

In some embodiments, the options 836a-836c include an option 836a to send a message to the users with whom the document 806 is shared, an option 836b to initiate a phone call with the users with which the document 806 is shared, and an option 836c to initiate a videoconference with the users with whom the document is shared. In some embodiments, in response to detecting selection of option 836a, the electronic device 500a displays the messaging user interface displayed in FIGS. 8C-8F and/or as described with reference to one or more steps of method(s) 700 and/or 1100. In some embodiments, the electronic device 500a initiates a phone call with the users with whom the document 806 is shared in response to detecting selection of the option 836b. In some embodiments, the electronic device 500a initiates a videoconference with the users with whom the document 806 is shared in response to detecting selection of the option 836c, optionally including one or more steps of method 1100.

As shown in FIG. 8H, the collaboration menu 842 includes an indication 838a of edits made to the shared document 806. In some embodiments, indication 838a includes an indication of the user that edited the document 806 and a timestamp of when the edit was made. In some embodiments, as shown in FIG. 8H, the indication 838a does not include an indication of the contents of the edit made to the shared document 806. In some embodiments, the collaboration menu 842 includes an indication 838b of the document 806 being created, including an indication of the user that created the document and the timestamp corresponding to when the document 806 was created.

As shown in FIG. 8H, the collaboration menu 842 includes indications 840a and 840b of users with access to the shared document 806. In some embodiments, in response to receiving selection of one of the indications 840a or 840b, such as detecting a tap at the location of one of the indications 840a or 840b, the electronic device 500a displays a contact card user interface for the user corresponding to the selected indication. In some embodiments, in response to detecting a swipe input on one of the indications 840a or 840b, the electronic device 500a initiates a process to remove a user from access to the shared document 806. For example, as shown in FIG. 8H, the electronic device 500a receives an input including a swipe (e.g., of contact 803h) on an indication 840b of one of the users. In response to receiving the input shown in FIG. 8H, the electronic device 500a displays an option to remove the user associated with indication 840b from the shared document 806, as shown in FIG. 8I.

FIG. 8I illustrates the document user interface updated in response to the input illustrated in FIG. 8H. As shown in FIG. 8I, the user interface includes an option 844 to remove the user associated with indication 840b from the shared document 806. In FIG. 8I, the electronic device 500a receives an input (e.g., with contact 803i) selecting the option 844. In response to the input shown in FIG. 8I, the electronic device 500a presents options for removing the user from the document only or removing the user from the document and the messaging conversation as shown in FIG. 8J.

FIG. 8J illustrates the electronic device 500a displaying an option 848a to remove the user from the messaging conversation and the shared document and an option 848b to remove the user from the shared document only in response to the input illustrated in FIG. 8I. In some embodiments, the options 848a and 848b are displayed in an indication 846 displayed overlaid on the shared document 806 that asks the user of the electronic device 500a whether the other user should be removed from the messaging conversation in addition to being removed from the shared document. As shown in FIG. 8J, the indication 846 further includes an option 848c to cease display of the indication 846 without removing the user from the shared document or the messaging conversation. FIG. 8J illustrates the electronic device 500a receiving an input (e.g., including contact 803j) selecting the option 848b to remove the user from the shared document without removing the user from the messaging conversation. In response to the input illustrated in FIG. 8J, the electronic device 500a removes the user from the shared document 806 and updates the shared document user interface as shown in FIG. 8K.

FIG. 8K illustrates the electronic device 500a displaying the user interface with the shared document 806 updated in response to the input illustrated in FIG. 8J and a second electronic device 500b belonging to the user that was removed from the shared document displaying the messaging conversation. As shown in FIG. 8K, the electronic device 500a the removed the user from the shared document 806 displays the shared document 806 in a user interface with the removed user no longer indicated in the collaboration menu 842 because the user no longer has access to the shared document. The electronic device 500a also updates the collaboration menu 842 to include an indication 834h of the user the document 806 is shared with and text 834d that indicates that the document is shared with that user, in place of an indication of a group of users the document 806 is shared with and text that indicates the messaging conversation of the group of users because the document 806 is no longer shared with the group of users. In some embodiments, while the shared document 806 is accessible to a subset of users in the shared conversation, selecting the communication options 836a-c cause the electronic device 500a to initiate communication with the user with whom the document 806 is shared, instead of the group of users in the messaging conversation. In some embodiments, while the shared document 806 is accessible to a subset of users in the shared conversation, selecting the communication options 836a-c cause the electronic device 500a to initiate communication with the group of users.

FIG. 8K also illustrates the second electronic device 500b used by the user that was removed from the shared document in response to the inputs illustrated in FIGS. 8I-8J. In some embodiments, in response to the user being removed from the shared document without being removed from the messaging conversation, the second electronic device 500b displays an indication in the messaging conversation similar to the indications described above with reference to method 700. For example, the indication indicates that the user was removed from the shared document and optionally includes an option to remove the user from the messaging conversation.

In FIG. 8K, the second electronic device 500b displays the messaging conversation including the indication 830b of the message that initially shared the shared document 806. As described above with reference to FIGS. 8B-8F, the indication 830b of the message includes a selectable option 812e that, when selected while the user of the second electronic device 500b had access to the shared document, causes the second electronic device 500b to display the shared document. In FIG. 8K, the user of the second electronic device 500b does not have access to the shared document, so selecting the option 812e does not cause the second electronic device 500b to display the shared document. For example, in FIG. 8K, the second electronic device 500b detects selection (e.g., via contact 803k) of the option 812e to access the shared document. Because the user of the electronic device 500b does not have access to the shared document when the input in FIG. 8K is received, in response to the input in FIG. 8K, the second electronic device 500b forgoes presenting the shared document as shown in FIG. 8L.

FIG. 8L illustrates an example of the second electronic device 500b presenting an indication 829 that the user of the second electronic device 500b no longer has access to the shared document, so the shared document is not displayed in response to the input received by the second electronic device 500b in FIG. 8K. In some embodiments, in response to the input illustrated in FIG. 8K, the electronic device 500b maintains display of the messaging conversation as shown in FIG. 8K without displaying the indication 829 illustrated in FIG. 8L. In some embodiments, in response to the input illustrated in FIG. 8K, the electronic device 500b displays a user interface of the document editing and/or viewing application associated with the shared document without displaying the shared document. In some embodiments, the electronic device 500b displays the indication 829 in the document editing and/or viewing application user interface instead of the messaging user interface in response to the input illustrated in FIG. 8K.

As shown in FIG. 8L, the indication 829 includes text that informs the user of the second electronic device 500b that the user no longer has access to the shared document and an option 831 that, when selected, causes the second electronic device 500b to cease display of the indication 829 in the messaging user interface.

In some embodiments, in response to adding a user to the shared document that does not currently have access to the messaging conversation, the electronic device 500a presents an option to add the user to the messaging conversation. For example, FIG. 8M illustrates the collaboration menu 842 overlaid on the shared document 806 while the users in the messaging conversation have access to the shared document. In FIG. 8M, the collaboration menu includes an image 834c and indication 834b that indicate the document is shared with the users in the messaging conversation and indications 840a and 840b of the users that have access to the shared document, who are also in the messaging conversation. As shown in FIG. 8M, the electronic device 500a receives an input (e.g., including contact 803m) selecting an option 840c to add another user to the shared document. In some embodiments, in response to the input illustrated in FIG. 8M, the electronic device 500a displays an option to add the user to the shared document without adding the user to the messaging conversation and an option to add the user to the shared document and the messaging conversation, as shown in FIG. 8N.

FIG. 8N illustrates the electronic device 500a displaying an indication 850 overlaid on the shared document 806 and collaboration menu 842 that includes an option 852a to add the user to the shared document and the messaging conversation and an option 852b to add the user to the shared document without adding the user to the messaging conversation. In some embodiments, the indication 850 includes text that asks the user whether to add the user to the shared document with or without adding the user to the messaging conversation too and an option 852c that, when selected, causes the electronic device 500a to cease display of the indication 850 without adding the user to either the shared document or the messaging conversation. As shown in FIG. 8N, the electronic device 500a receives an input (e.g., including contact 803n) selecting the option 852a to add the user to the shared document and the messaging conversation. In response to the input illustrated in FIG. 8N, the electronic device 500a updates the document editing and/or viewing user interface as shown in FIG. 8O.

FIG. 8O illustrates the document editing and/or viewing user interface with the shared document 806 updated in response to the input illustrated in FIG. 8N. In FIG. 8O, the collaboration menu 842 is updated to include an indication 834g and text 834f that reflect the updated messaging conversation that includes the user added to the messaging conversation and shared document in response to the input illustrated in FIG. 8N. In some embodiments, the collaboration menu 842 is further updated to include an indication 840d of the user that was added to the shared document 806.

In some embodiments, in response to adding or removing users from the messaging conversation without adding or removing the users from the shared document, the electronic device 500a presents an option to add or remove the users from the shared document in addition to the messaging conversation. FIG. 8P illustrates the electronic device 500a displaying the messaging conversation after the user was added to the messaging conversation and shared document in response to the sequence of inputs illustrated in FIGS. 8M-8O. In some embodiments, the messaging conversation includes the message 830b sharing the shared document and an indication 854 of the user that was added in FIGS. 8M-8O. In FIG. 8P, the electronic device 500a receives an input (e.g., including contact 803p) selecting an option 822c to view a settings user interface associated with the messaging conversation. In response to the input illustrated in FIG. 8P, the electronic device 500a displays the settings user interface in FIG. 8Q.

FIG. 8Q illustrates the electronic device 500a displaying a settings user interface associated with a messaging conversation in response to the input illustrated in FIG. 8P. The settings user interface includes an option 856a to navigate back to the messaging conversation, an image 856b associated with the messaging conversation, options 858a-858c for contacting the participants in the messaging conversation using communication methods other than the messaging conversation, indications 860b-860d of the users in the messaging conversation and an option 860e to add another user to the messaging conversation. In some embodiments, the elements of the settings user interface illustrated in FIG. 8Q are similar to the elements in the messaging conversation user interface described above with reference to method 700. In FIG. 8Q, the electronic device 500a receives an input (e.g., including movement of contact 803q) that corresponds to a request to display an option to remove the user associated with indication 860c from the messaging conversation. In response to the input illustrated in FIG. 8Q, the electronic device 500a updates indication 860c to include the option to remove the user from the messaging conversation, as shown in FIG. 8R.

FIG. 8R illustrates the settings user interface updated in response to the input illustrated in FIG. 8Q. In some embodiments, in response to the input in FIG. 8Q, the electronic device 500a updates the settings user interface to include an option 862 to remove the user associated with indication 860c from the messaging conversation, as shown in FIG. 8R. In FIG. 8R, the electronic device 500a receives an input (e.g., including contact 803r) selecting the option 862 to remove the user from the messaging conversation. In some embodiments, in response to the input illustrated in FIG. 8R, the electronic device 500a removes the user from the messaging conversation without removing the user from the shared document, as shown in FIG. 8S.

FIG. 8S illustrates the messaging conversation settings user interface updated to remove a user from the messaging conversation in response to the input illustrated in FIG. 8R. In some embodiments, the electronic device 500a removes the user from the messaging conversation but does not remove the user from the shared document in response to the input in FIG. 8R. In FIG. 8S, the electronic device 500a displays the user interface updated to no longer include the indication of the user that was removed from the messaging conversation. In some embodiments, the updated user interface includes an indication 856c of the users that remain in the messaging conversation. In some embodiments, the electronic device 500a displays an indication overlaid on the settings user interface that includes an option to remove the user from both the messaging conversation and the shared document and an option to remove the user from the messaging conversation without removing the user from the shared document. In some embodiments, the indication is similar to the indications 846 and 850 described above with reference to FIGS. 8J and 8N, respectively. As shown in FIG. 8S, the electronic device 500a receives an input (e.g., including contact 803s) selecting the option 856a to cease display of the messaging conversation settings user interface and return to the messaging conversation. In some embodiments, in response to receiving the input in FIG. 8S, the electronic device 500a displays the messaging conversation, as shown in FIG. 8T.

FIG. 8T illustrates an example of the electronic device 500a displaying the messaging conversation after one of the users was removed from the messaging conversation without being removed from the shared document. In some embodiments, the electronic device 500a displays indications 866 and 864 that the user was added to the messaging conversation. In some embodiments, indication 866 has one or more characteristics in common with indications described above with reference to method 700. For example, the indication 866 includes text that indicates that the user was removed from the conversation and asks whether the user should be added to the shared document, a selectable option 868a that, when selected, causes the electronic device 500a to cease display of the indication 866 without adding the user to the shared document and a selectable option 868b that, when selected, causes the electronic device 500a to add the user to the shared document. In some embodiments, the electronic devices of other users in the messaging conversation display the indication 866 overlaid on the messaging conversation when displaying the messaging conversation. In some embodiments, the electronic device 500a of the user that added the other user to the conversation displays indication 866, but the other electronic devices in the messaging conversation do not display indication 866 when displaying the messaging conversation. In some embodiments, in response to detecting selection of option 868b the electronic device 500a adds the user to the shared document and ceases display of indication 866 and optionally causes other electronic devices in the messaging conversation to cease display of indication 866 when displaying the messaging conversation.

As shown in FIG. 8T, the electronic device 500a detects selection (e.g., including contact 803t) of the option 822f to display the settings user interface for the messaging conversation. In response to the input illustrated in FIG. 8T, the electronic device 500a displays the settings user interface for the messaging conversation, as shown in FIG. 8U.

FIG. 8U illustrates the electronic device 500a displaying the settings user interface for the messaging conversation in response to the input illustrated in FIG. 8T. In some embodiments, the settings user interface is the same as the user interface illustrated in FIG. 8S. As shown in FIG. 8U, the electronic device 500a receives an input selecting (e.g., with contact) the option 860e to add another user to the messaging conversation. In some embodiments, in response to the input illustrated in FIG. 8U, the electronic device 500a initiates a process to add another user to the messaging conversation, which optionally includes displaying a user interface for selecting or searching for a contact to add to the messaging conversation and/or for entering a phone number, e-mail address, or other messaging address of another person to be added to the messaging conversation. In some embodiments, in response to receiving a sequence of inputs including the input in FIG. 8U and one or more additional inputs selecting a user to be added to the messaging conversation, the electronic device 500a updates the message conversation settings user interface to indicate that the user was added to the messaging conversation, as shown in FIG. 8V.

FIG. 8V illustrates the electronic device 500a displaying the messaging conversation settings user interface updated in response to the sequence of inputs including the input in FIG. 8U to add another user to the messaging conversation. As shown in FIG. 8V, the electronic device 500a updates the messaging conversation settings user interface to include an indication 856c of the updated group of users in the conversation and an indication 860e of the user added to the messaging conversation in response to the sequence of inputs including the input in FIG. 8U. In some embodiments, the electronic device 500a displays an indication overlaid on the settings user interface that includes an option to remove the user from both the messaging conversation and the shared document and an option to remove the user from the messaging conversation without removing the user from the shared document. In some embodiments, the indication is similar to the indications 846 and 850 described above with reference to FIGS. 8J and 8N, respectively. As shown in FIG. 8V, the electronic device 500a receives an input (e.g., including contact 803v) selecting the option 856a to cease display of the messaging conversation settings user interface and return to the messaging conversation. In some embodiments, in response to receiving the input in FIG. 8V, the electronic device 500a displays the messaging conversation, as shown in FIG. 8W.

FIG. 8W illustrates the electronic device 500a displaying the messaging conversation in response to the input illustrated in FIG. 8V. In some embodiments, the messaging conversation is updated to include indications 872 and 870 that another user was added to the messaging conversation. In some embodiments, the indication 872 has one or more characteristics of indications described above with reference to method 700. For example, the indication 872 includes text that indicates the user was added to the messaging conversation and a prompt asking whether to add the user to the shared document, an option 868a to cease display of the indication 872 without adding the user to the shared document, and an option 868c to add the user to the shared document. In some embodiments, the other electronic devices with access to the messaging conversation and the shared document also display indication 872 overlaid on the messaging conversation when displaying the messaging conversation. In some embodiments, if the user is added to the shared document, the electronic devices cease displaying the indication 872 overlaid on the messaging conversation when displaying the messaging conversation.

FIGS. 9A-9B is a flowchart illustrating an exemplary method 900 of presenting options to update the users with access to shared documents and/or messaging conversations in accordance with some embodiments of the disclosure. The method 900 is optionally performed at an electronic device such as device 100, device 300, device 500, device 501, device 510, and device 591 as described above with reference to FIGS. 1A-1B, 2-3, 4A-4B and 5A-5I. Some operations in method 900 are, optionally combined and/or order of some operations is, optionally, changed.

As described below, the method 900 provides for interaction with shared documents and/or messaging conversations. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed at an electronic device (e.g., 500a) in communication with a display generation component (e.g., 504a) and one or more input devices, such as in FIG. 8A. For example, the electronic device is the electronic device described above with reference to method 700. In some embodiments, the display generation component is the display generation component described above with reference to method 700.

In some embodiments, such as in FIG. 8J, while a first group of users, including a user of the electronic device (e.g., 500a), has access to a messaging conversation and while the first group of users has access to a shared document, the electronic device (e.g., 500a) receives (902), via the one or more input devices, an input associated with the shared document or the messaging conversation. In some embodiments, prior to the electronic device receiving the input, the shared document and the messaging conversation are accessible to the same first group of users. In some embodiments, the shared document has one or more characteristics of the shared document described above with reference to method 700. In some embodiments, the messaging conversation has one or more characteristics of the messaging conversation described above with reference to method 700.

In some embodiments, in response to receiving the input (904), in accordance with a determination that the input corresponds to a request to make the messaging conversation accessible to a second group of users different from the first group of users (but not accessible to the first group of users) while the shared document remains accessible to the first group of users (906) (but not the second group of users), such as in FIG. 8R, the electronic device (e.g., 500a) updates (908) the messaging conversation to be accessible to the second group of users (but not the first group of users) while the shared document remains accessible to the first group of users (but not the second group of users). In some embodiments, the input corresponding to the request to make the messaging conversation accessible to the second group of users while the shared document remains accessible to the first group of users is received while displaying a user interface of the messaging application associated with the messaging conversation and/or is directed to the user interface of the messaging application (and optionally while not displaying the shared document and/or optionally not directed to the shared document or a user interface associated with the shared document). In some embodiments, the input corresponds to a request to add a respective user to the messaging conversation without adding the respective user to the shared document. In some embodiments, the input corresponds to a request to remove a respective user from the messaging conversation without removing the respective user from the shared document. In some embodiments, updating the messaging conversation to be accessible to the second group of users causes the electronic devices of users included in the second group of users to display a visual indication in the messaging conversation indicating the change in users that have access to the messaging conversation according to one or more steps of method 700.

In some embodiments, in response to receiving the input (904), in accordance with a determination that the input corresponds to a request to make the messaging conversation accessible to a second group of users different from the first group of users (but not accessible to the first group of users) while the shared document remains accessible to the first group of users (906) (but not the second group of users), the electronic device (e.g., 500a) displays (910), via the display generation component (e.g., 504a), a selectable option (e.g., 868b) that, when selected, causes the electronic device (e.g., 500a) to update the shared document to be accessible to the second group of users (but not the first group of users), such as in FIG. 8T. In some embodiments, the selectable option is displayed in the user interface of the messaging application associated with the messaging conversation (and not in the user interface associated with the messaging conversation). In some embodiments, if the input corresponds to a request to add a respective user to the messaging conversation without adding the respective user to the shared document, in response to detecting selection of the selectable option, the electronic device adds the respective user to the shared document. In some embodiments, if the input corresponds to a request to remove a respective user from the messaging conversation without removing the respective user from the shared document, in response to detecting selection of the selectable option, the electronic device removes the respective user from the shared document. In some embodiments, detecting selection of the selectable option causes the electronic devices with access to the messaging conversation to display an indication of the change to the users that have access to the shared document in the user interface that presents the messaging conversation according to one or more steps of method 700. In some embodiments, if the electronic device does not detect selection of the selectable option, the electronic device forgoes updating the users with access to the shared document, so the messaging conversation will be accessible to the second group of users while the shared document is accessible to the first group of users.

In some embodiments, in response to receiving the input (904), in accordance with a determination that the input corresponds to a request to make the shared document accessible to the second group of users (but not the first group of users) while the messaging conversation remains accessible to the first group of users (912) (but not the second group of users), the electronic device (e.g., 500a) updates (914) the shared document to be accessible to the second group of users (but not the first group of users) while the messaging remains accessible to the first group of users (but not the second group of users), such as in FIG. 8K. In some embodiments, the input corresponding to the request to make the shared document accessible to the second group of users while the messaging conversation remains accessible to the first group of users is received while displaying a user interface associated with the shared document and/or is directed to the user interface associated with the shared document (and optionally while not displaying the messaging conversation and/or optionally not directed to the messaging conversation or a user interface associated with the messaging conversation). In some embodiments, the input corresponds to a request to add a respective user to the shared document without adding the respective user to the messaging conversation. In some embodiments, the input corresponds to a request to remove a respective user from the shared document without removing the respective user from the messaging conversation. In some embodiments, updating the shared document to be accessible to the second group of users causes the electronic devices of users with access to the messaging conversation to display a visual indication in the messaging conversation indicating the change in users that have access to the shared document according to one or more steps of method 700.

In some embodiments, in response to receiving the input (904), in accordance with a determination that the input corresponds to a request to make the shared document accessible to the second group of users (but not the first group of users) while the messaging conversation remains accessible to the first group of users (912) (but not the second group of users), the electronic device (e.g., 500a) displays (916), via the display generation component (e.g., 504a), a selectable option (e.g., 848a) that, when selected, causes the electronic device (e.g., 500a) to update the messaging conversation to be accessible to the second group of users (but not the first group of users), such as in FIG. 8J. In some embodiments, the selectable option is displayed in the user interface of the application associated with the shared document (and not in the user interface associated with the messaging conversation). In some embodiments, if the input corresponds to a request to add a respective user to the shared document without adding the respective user to the messaging conversation, in response to detecting selection of the selectable option, the electronic device adds the respective user to the messaging conversation. In some embodiments, if the input corresponds to a request to remove a respective user from the shared document without removing the respective user from the messaging conversation, in response to detecting selection of the selectable option, the electronic device removes the respective user from the messaging conversation. In some embodiments, detecting selection of the selectable option causes the electronic devices with access to the messaging conversation to display an indication of the change to the users that have access to the messaging conversation in the user interface that presents the messaging conversation according to one or more steps of method 700. In some embodiments, if the electronic device does not detect selection of the selectable option, the electronic device forgoes updating the users with access to the messaging conversation, so the messaging conversation will be accessible to the first group of users while the shared document is accessible to the second group of users. In some embodiments, in response to detecting an input corresponding to a request to make the messaging conversation accessible to the second group of users while the shared document remains accessible to the first group of users or a request to make the shared document accessible to the second group of users while the messaging conversation remains accessible to the first group of users, the electronic device displays a selectable option that, when selected, causes the electronic device to make the shared document and the messaging conversation accessible to the second group of users. Displaying the option to make the shared document and the messaging conversation accessible to the second group of users in response to an input corresponding to a request to make the messaging conversation accessible to the second group of users while the shared document remains accessible to the first group of users or a request to make the shared document accessible to the second group of users while the messaging conversation remains accessible to the first group of users enhances user interactions with the electronic device by reducing the number of inputs to synchronize the group of users with access to the shared document and the group of users with access to the messaging conversation.

In some embodiments, the messaging conversation includes a message sharing the shared document, and an indication (e.g., 830b) of the message in the messaging conversation includes a selectable option (e.g., 812e) to access the shared document, such as in FIG. 8F. In some embodiments, the indication of the message further includes an indication of the name of the document. In some embodiments, the indication of the message is displayed in association with an indication of the user that shared the document, such as the name of the user and/or an image associated with the user, such as an image included in the user's contact card.

In some embodiments, such as in FIG. 8F, while displaying the messaging conversation, the electronic device (e.g., 500a) receives, via the one or more input devices, an input corresponding to selection of the selectable option (e.g., 812e) to access the shared document.

In some embodiments, in response to receiving the input corresponding to selection of the selectable option (e.g., 812e) to access the shared document, such as in FIG. 8F, in accordance with a determination that the shared document is accessible to the user of the electronic device (e.g., 500a), the electronic device (e.g., 500a) displays, via the display generation component (e.g., 504a), the shared document (806), such as in FIG. 8G. In some embodiments, sharing the shared document with the messaging conversation makes the shared document accessible to the users in the messaging conversation unless and until a respective user is removed from the shared document. In some embodiments, displaying the shared document includes ceasing display of the messaging conversation.

In some embodiments, in response to receiving the input corresponding to selection of the selectable option (e.g., 812e) to access the shared document, such as in FIG. 8K, in accordance with a determination that the shared document is not accessible to the user of the electronic device (e.g., 500b), the electronic device (e.g., 500b) forgoes displaying, via the display generation component (e.g., 504b), the shared document, such as in FIG. 8L. In some embodiments, the user does not have access to the shared document because another user removed them from the shared document (after having access to the shared document) according to one or more techniques described herein. In some embodiments, in response to receiving the input, in accordance with the determination that the shared document is not accessible to the user of the electronic device, the electronic device maintains display of the messaging conversation and/or displays an error message indicating the user does not have access to the shared document. In some embodiments, the electronic device displays the indication of the message sharing the shared document irrespective of whether or not the user has access to the shared document. In some embodiments, while the user has access to the shared document, in response to detecting selection of an option included in the message, the electronic device displays the shared document. Selectively accessing the shared document in response to receiving the input selecting the selectable option enhances user interactions with the electronic device by improving user privacy.

In some embodiments, in response to receiving the input, in accordance with a determination that the input corresponds to a request to make the shared document (e.g., 806) accessible to a respective user not included in the first group of users (without adding the respective user to the messaging conversation), such as in FIG. 8M, the electronic device (e.g., 500a) updates the shared document (e.g., 806) to be accessible to the first group of users and the respective user (without making the messaging conversation accessible to the respective user).

In some embodiments, in response to receiving the input, in accordance with a determination that the input corresponds to a request to make the shared document (e.g., 806) accessible to a respective user not included in the first group of users (without adding the respective user to the messaging conversation), the electronic device (e.g., 500a) displays, via the display generation component (e.g., 504a), a selectable option (e.g., 852a) that, when selected, causes the electronic device (e.g., 500a) to update the messaging conversation to be accessible to the first group of users and the respective user. In some embodiments, the input is received while displaying the shared document and the selectable option is displayed concurrently with the shared document. In some embodiments, the selectable option is displayed in an indication in the messaging conversation according to one or more steps of method 700 above. In some embodiments, in response to detecting selection of the selectable option, the first group of users and the respective user have access to the messaging conversation and the shared document. In some embodiments, the respective user has access to the shared document without having access to the messaging conversation unless and until an input granting the respective user access to the messaging conversation and/or an input removing the respective user from the shared document is received. Displaying an option to update the messaging conversation to be accessible to the respective user in response to the input to make the shared document accessible to the respective user enhances user interactions with the electronic device by reducing the number of inputs needed to resolve discrepancies between users that are able to access the shared document and users that are able to access the messaging conversation.

In some embodiments, while displaying the selectable option (e.g., 842b in FIG. 8N) that, when selected, causes the electronic device to update the messaging conversation to be accessible to the first group of users and the respective user and while the shared document (e.g., 806 in FIG. 8N) is accessible to the first group of users and the respective user (and the messaging conversation is accessible to the first group of users and not the respective user), the electronic device (e.g., 500a) receives, via the one or more input devices, an input selecting the selectable option (e.g., 842b) that, when selected, causes the electronic device (e.g., 500a) to update the messaging conversation to be accessible to the first group of users and the respective user.

In some embodiments, in response to receiving the input selecting the selectable option (e.g., 842b in FIG. 8N) that, when selected, causes the electronic device (e.g., 500a) to update the messaging conversation to be accessible to the first group of users and the respective user, the electronic device (e.g., 500a) updates the messaging conversation to be accessible to the first group of users and the respective user. In some embodiments, the messaging conversation is not accessible to the respective user unless and until a request to add the respective user to the messaging conversation is received. Adding the respective user to the messaging conversation and the shared document enhances user interactions with the electronic device by reducing the number of inputs needed to message the users that have access to the shared document.

In some embodiments, in response to receiving the input, in accordance with the determination that the input corresponds to the request to make the shared document accessible to the respective user not included in the first group of users, such as in FIGS. 8M-8N, the electronic device (e.g., 500a) forgoes updating the messaging conversation to be accessible to the respective user (e.g., unless and until the electronic device detects selection of the selectable option that, when selected, causes the electronic device to update the messaging conversation to be accessible to the first group of users and the respective user, another input allowing the respective user to access the messaging conversation is received, and/or an indication that another user in the first group of users allowed the respective user to access the messaging conversation is received). In some embodiments, in response to receiving the input corresponding to the request to make the shared document accessible to the respective user, the electronic device displays the option to add the respective user to the group messaging conversation. In some embodiments, the option is displayed overlaid on the shared document. In some embodiments, in response to receiving the input corresponding to the request to make the shared document accessible to the respective user, the electronic device additionally displays an option to cease display of the option to add the respective user to the messaging conversation. In some embodiments, in response to detecting selection of the option to cease display of the option to add the respective user to the messaging conversation, the electronic device forgoes updating the messaging conversation to be accessible to the respective user. Forgoing adding the respective user to the messaging conversation enhances user interactions with the electronic device by improving user privacy.

In some embodiments, in response to receiving the input, in accordance with a determination that the input corresponds to a request to make the shared document not accessible to a respective user included in the first group of users (e.g., without removing the respective user from the messaging conversation, and optionally without removing any other users from the first group of users from the shared document), such as in FIG. 8I, the electronic device (e.g., 500a) updates the shared document (e.g., 806) not to be accessible to the respective user (without updating the messaging conversation not to be accessible to the respective user). In some embodiments, in response to receiving the input, in accordance with the determination that the input corresponds to the request to make the shared document not accessible to the respective user, the electronic device forgoes updating the shared document not to be accessible to one or more additional users in the first group of users.

In some embodiments, in response to receiving the input, in accordance with a determination that the input corresponds to a request to make the shared document not accessible to a respective user included in the first group of users (e.g., without removing the respective user from the messaging conversation, and optionally without removing any other users from the first group of users from the shared document), such as in FIG. 8I, the electronic device (e.g., 500a) displays, via the display generation component, a selectable option (e.g., 848a) that, when selected, causes the electronic device to update the messaging conversation not to be accessible to the respective user, such as in FIG. 8J. In some embodiments, the input is received while the electronic device displays the shared document. In some embodiments, the electronic device displays the selectable option overlaid on the shared document. In some embodiments, updating the messaging conversation not to be accessible to the user removes the user from the messaging conversation so that additional messages sent to the messaging conversation are not sent to the user. In some embodiments, a user that is removed from a messaging conversation does not have access to messages sent to the messaging conversation while they had access to the messaging conversation. In some embodiments, a user that is removed from a messaging conversation does has access to messages sent to the messaging conversation while they had access to the messaging conversation, but does not receive messages added to the messaging conversation after they were removed from the messaging conversation. Displaying the option to update the messaging conversation not to be accessible to the respective user in response to the input to update the shared document not to be accessible to the respective user enhances user interactions with the electronic device by reducing the number of inputs needed to resolve a discrepancy between the users with access to the messaging conversation and the users with access to the shared document.

In some embodiments, in response to receiving the input, in accordance with a determination that the input corresponds to a request to make the messaging conversation accessible to a respective user not included in the first group of users, such as in FIG. 8U, the electronic device (e.g., 500a) updates the messaging conversation to be accessible to the respective user and the first group of users (without updating the shared document to be accessible to the respective user). In some embodiments, the electronic device receives the input while displaying a messaging application that includes the messaging conversation.

In some embodiments, in response to receiving the input, in accordance with a determination that the input corresponds to a request to make the messaging conversation accessible to a respective user not included in the first group of users, such as in FIG. 8U, while displaying the messaging conversation in a messaging user interface (e.g., 820), the electronic device (e.g., 500a) displays, via the display generation component (e.g., 504a), a selectable option (e.g., 868c) that, when selected, causes the electronic device (e.g., 500a) to update the shared document to be accessible to the respective user and the first group of users, such as in FIG. 8W. In some embodiments, the selectable option is displayed in an indication that the respective user was added to the messaging conversation according to one or more steps of method 700. In some embodiments, in response to detecting selection of the selectable option, the electronic device updates the shared document to be accessible to the respective user and the first group of users. In some embodiments, the shared document is not accessible to the respective user unless and until the respective user is added to the shared document, such as in response to the electronic device detecting selection of the selectable option. Displaying the option to update the shared document to be accessible to the respective user and the first group of users in response to the input to update the messaging conversation to be accessible to the respective user and the first group of users enhances user interactions with the electronic device by reducing the number of inputs needed to resolve discrepancies between the users with access to the shared document and users with access to the messaging conversation.

In some embodiments, in response to receiving the input, in accordance with a determination that the input corresponds to a request to make the messaging conversation not accessible to a respective user included in the first group of users (while the messaging conversation remains accessible to the other users included in the first group of users, and without making the shared document not accessible to the respective user), such as in FIG. 8R, the electronic device (e.g., 500a) updates the messaging conversation not to be accessible to the respective user. In some embodiments, in response to receiving the input, the messaging conversation remains accessible to the other users in the first group of users and the shared document remains accessible to the respective user. In some embodiments, receiving the input includes detecting selection of an option to remove the respective user from the messaging conversation displayed in a user interface of a messaging application that includes the messaging conversation.

In some embodiments, in response to receiving the input, in accordance with a determination that the input corresponds to a request to make the messaging conversation not accessible to a respective user included in the first group of users (while the messaging conversation remains accessible to the other users included in the first group of users, and without making the shared document not accessible to the respective user), such as in FIG. 8R, while displaying the messaging conversation in a messaging user interface, the electronic device (e.g., 500a) displays, via the display generation component, a selectable option (e.g., 868b) that, when selected, causes the electronic device (e.g., 500a) to update the shared document not to be accessible to the respective user. In some embodiments, the selectable option is displayed in an indication of a change to the first group of users that have access to the messaging conversation in accordance with one or more steps of method 700. In some embodiments, the respective user has access to the shared document unless and until a request to remove the respective user from the shared document is received, such as the electronic device detecting selection of the selectable option. In some embodiments, in response to the electronic device detecting selection of the selectable option, the shared document is updated so that the respective user no longer has access to the shared document. Displaying the selectable option to remove the respective user from the shared document in response to the request to remove the user from the messaging conversation enhances user interactions with the electronic device by reducing the number of inputs needed to resolve discrepancies between the users with access to the shared document and users with access to the messaging conversation.

In some embodiments, while the shared document is not accessible to the first group of users or the second group of users (but is accessible to the user of the electronic device 500a), while displaying the shared document (e.g., 806) in a user interface that includes a share option (802c), the electronic device (e.g., 500a) receives, via the one or more input devices, an input (e.g., including contact 803a) selecting the share option (802c). In some embodiments, the share option is displayed concurrently with additional selectable options for performing actions related to the shared document, such as an undo option, a formatting option, and/or a proofreading option.

In some embodiments, while the shared document is not accessible to the first group of users or the second group of users (but is accessible to the user of the electronic device 500a), in response to the input selecting the share option (e.g., 802c), the electronic device (e.g., 500a) displays a sharing user interface that includes an option (e.g., 816c) to share the shared document in the messaging conversation and a first option (e.g., 812b and/or 812c) to change a setting for sharing the document. In some embodiments, the sharing user interface includes a plurality of selectable options that, when selected, cause the electronic device to initiate a process to share the shared document using various respective sharing protocols, such as the application of the messaging conversation, an e-mail application, and/or generation of a link to be copied and pasted into another communication application. In some embodiments, in response to detecting selection of the first option, the electronic device displays options for sharing the shared document to allow the users receiving the shared document to edit the shared document or sharing the shared document to allow users to view the shared document without editing the shared document. Displaying the sharing user interface with the first option to change the setting for sharing the document enhances user interactions with the electronic device by improving user privacy.

In some embodiments, such as in FIG. 8B, while displaying the sharing user interface, the electronic device (e.g., 500a) receives an input selecting the option (e.g., 816c) to share the shared document (e.g., 806) in the messaging conversation. In some embodiments, the option is an option to share the shared document with the application of the messaging conversation and, in response to detecting selection of the option, the electronic device presents a user interface for composing a new message that includes a text entry field to which the electronic device accepts an input identifying the recipients of the new message. In some embodiments, while displaying the user interface, the electronic device receives an input identifying the messaging conversation as the recipients of the message including the shared document. In some embodiments, the options is an option to share the shared document with the messaging conversation and, in response to detecting selection of the shared document, the electronic device displays a user interface identifying the messaging conversation as the recipient of the message including the shared document.

In some embodiments, in response to receiving the input selecting the option to share the shared document in the messaging conversation, the electronic device (e.g., 500a) displays, via the display generation component (e.g., 504a), a messaging user interface that includes the messaging conversation and a message composition field (e.g., 827) that includes an indication (e.g., 830a) of a message sharing the shared document, wherein the indication (e.g., 830a) of the message includes a second option (e.g., 812b and/or 812c) to change the setting for sharing the document. In some embodiments, the electronic device displays text and/or images to be included in a message to the messaging conversation in the message composition field. In some embodiments, in response to detecting selection of the message composition field, the electronic device directs input focus to the message composition field, which causes further text inputs to enter text to the message composition field. In some embodiments, the indication of the message includes an indication of the name of the document. In some embodiments, once the message is sent, in response to detecting selection of the representation of the message, the electronic device displays the shared document.

In some embodiments, while displaying the message composition field (e.g., 827) that includes the indication (e.g., 830a) of the message sharing the shared document, such as in FIG. 8C, the electronic device (e.g., 500a) receives, via the one or more input devices, an input (e.g., including contact 803c) selecting the second option (e.g., 812b).

In some embodiments, while displaying the message composition field (e.g., 827) that includes the indication (e.g., 830a) of the message sharing the shared document, such as in FIG. 8C, in response to receiving the input selecting the second option (e.g., 812b), the electronic device (e.g., 500a) initiates a process to change the setting for sharing the document, such as in FIG. 8D. In some embodiments, in response to detecting one or more inputs changing the setting for sharing the document followed by an input sharing the document, the electronic device shares the document with the group messaging conversation with the selected setting. For example, the setting is a setting to allow users with which the document is shared to edit the document or to allow the users with which the document is shared to view the document without editing the document, as described above. Displaying the option to change the setting for sharing the document in the messaging user interface enhances user interactions with the electronic device by reducing the number of inputs needed to change the settings for sharing the document.

It should be understood that the particular order in which the operations in FIGS. 9A-9B have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method(s) 700 and/or 1100) are also applicable in an analogous manner to method 900 described above with respect to FIGS. 9A-9B. For example, the operation of the electronic device presenting options to update the users with access to shared documents and/or messaging conversations in accordance with some embodiments of the disclosure described above with reference to method 900 optionally has one or more of the characteristics of presenting indications of changes to a shared document and/or to the users in a messaging conversation while displaying the messaging conversation and/or participating in communication sessions associated with a shared document described herein with reference to other methods described herein (e.g., method(s) 700 and/or 1100). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIGS. 9A-9B are, optionally, implemented by components depicted in FIGS. 1A-1B. For example, displaying operations 910 and/or 916, receiving operation 902, and/or updating operations 908 and/or 914 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Initiating Communication with Users with Access to a Shared Document

Users interact with electronic devices in many different manners. In some embodiments, an electronic device accesses a shared document accessible by one or more other users and initiates communication sessions with the one or more other users. The embodiments described below provide ways in which an electronic device initiates and participates in communication sessions associated with the shared document. For example, the electronic device displays options for contacting users with access to a shared document in the user interface that includes the shared document. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

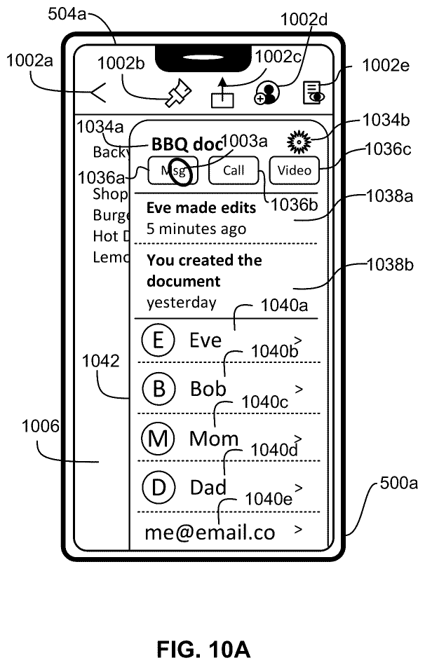

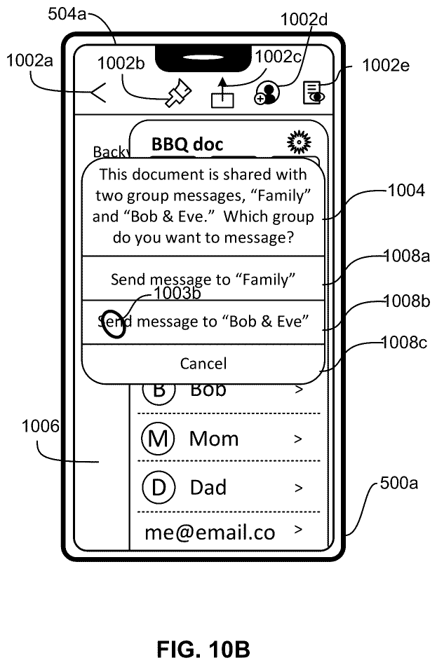

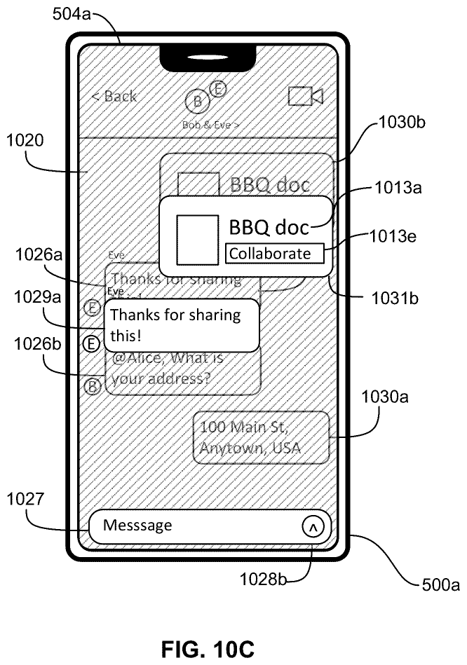

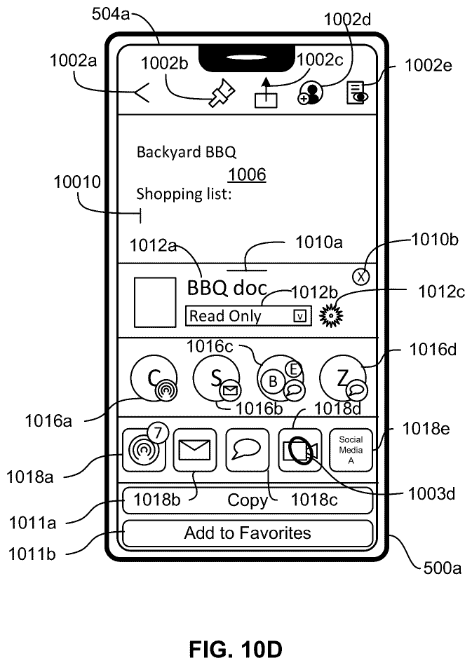

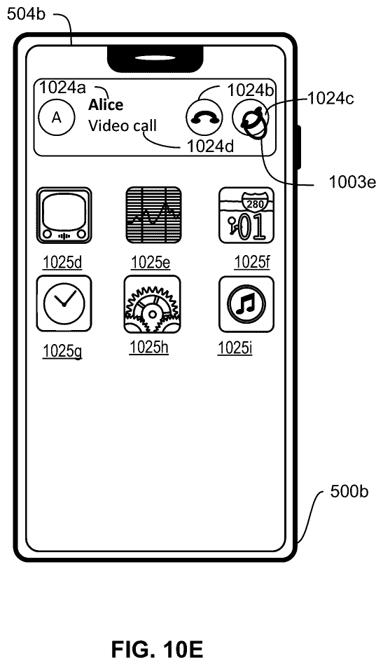

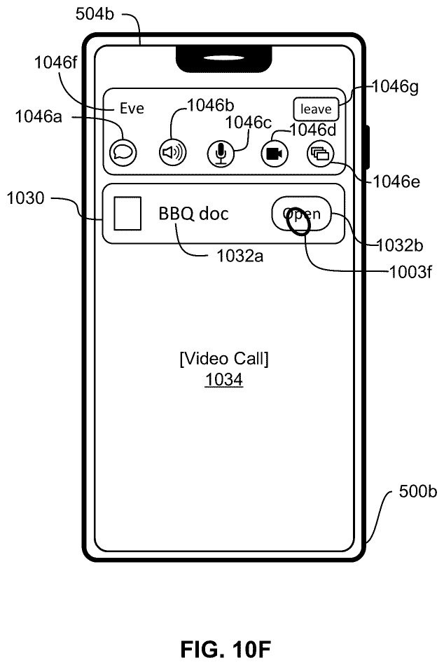

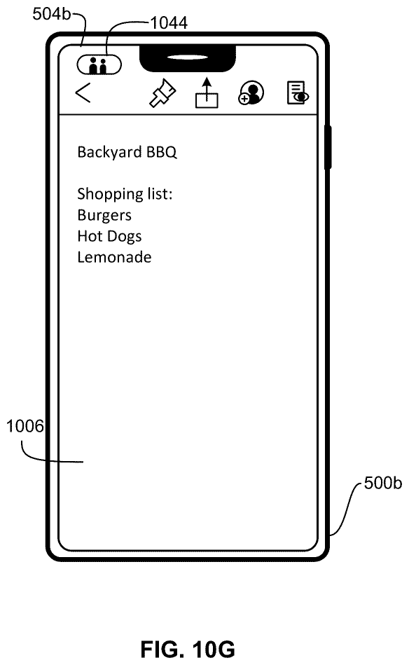

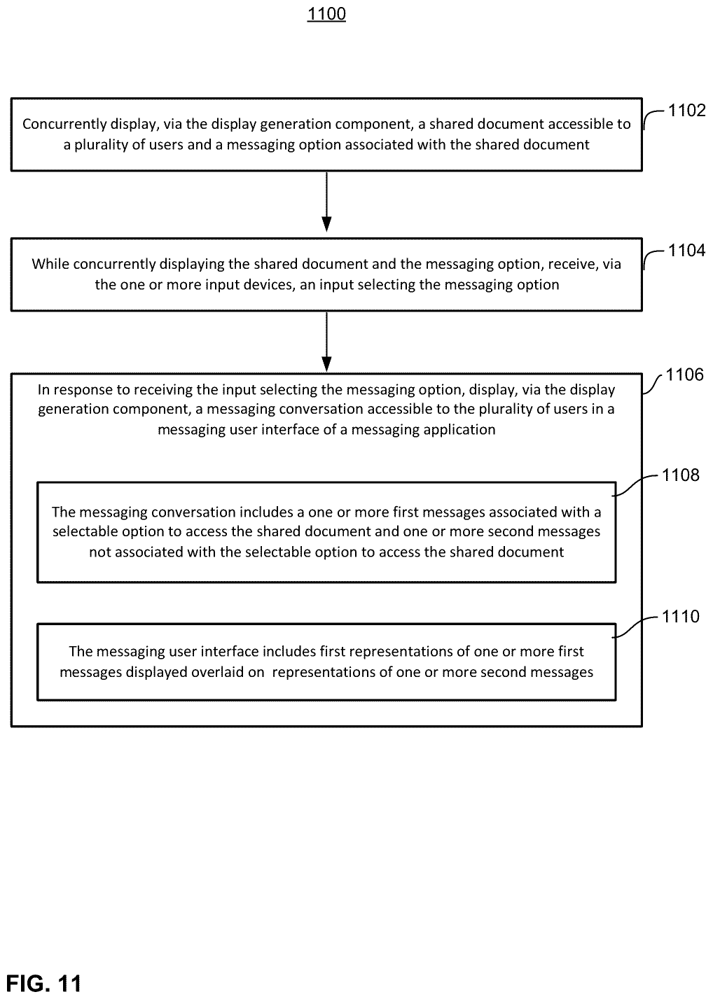

FIGS. 10A-10G illustrate exemplary ways of participating in communication sessions associated with a shared document in accordance with some embodiments of the disclosure. The embodiments in these figures are used to illustrate the processes described below, including the processes described with reference to FIG. 11.

FIG. 10A illustrates the electronic device 500a displaying a collaboration menu 1042 overlaid on a shared document 1006 in a document viewing and/or editing user interface. In some embodiments, the document viewing and/or editing user interface is similar to the document viewing and/or editing user interfaces described above with reference to method(s) 700 and/or 900 and includes a back option 1002a, a formatting option 1002b, a sharing option 1002c, a collaboration menu option 1002d, a proofreading option 1002e, and the shared document 1006. In some embodiments, the electronic device 500a displays the collaboration menu 1042 overlaid on the shared document 1006 in response to detecting selection of the collaboration menu option 1002d.

As shown in FIG. 10A, the collaboration menu 1042 includes the title 1034a of the document, a settings option 1034b, options 1036a through 1036c for contacting the users with whom the document is shared, indications 1038a and 1038b of activity in the document, and indications 1040a through 1040e of users with whom the document 1006 is shared. In some embodiments, collaboration menu 1042 has one or more characteristics in common with the collaboration menu described above with reference to method 900. In FIG. 10A, the shared document 1006 is shared with users Eve and Bob, corresponding to indications 1040a and 1040b, respectively, that are part of a first messaging conversation, users Mom and Dad, corresponding to indications 1040c and 10140d, respectively, and a user corresponding to indication 1040e that received the shared document via e-mail, rather than through a messaging conversation. In some embodiments, because the document 1006 is shared with users from multiple messaging conversations, the collaboration menu 1042 does not include an indication of a messaging conversation associated with the shared document because multiple messaging conversations are associated with the shared document 1006.

In some embodiments, if the shared document 1006 was shared with a group of users associated with a messaging conversation (e.g., the users with access to the messaging conversation is the same as the group of users with access to the shared document), in response to detecting selection of the message option 1036a, the electronic device 500a would display the messaging conversation associated with the shared document. In some embodiments, if the users with access to the shared document have access to different messaging conversation, in response to detecting selection of the message option 1036a, the electronic device 500a displays options for choosing the messaging conversation to send the message to from the messaging conversations associated with the shared document. In some embodiments, if one or more users with access to the shared document received the shared document through a communication method other than a messaging conversation, such as e-mail, the electronic device 500a forgoes sending a message to those users in response to detecting selection of the message option 1036a. As shown in FIG. 10A, the electronic device 500a receives an input (e.g., including contact 1003a) selecting the option 1036a to send a message to users with access to the shared document. Because the shared document is shared with multiple messaging conversations, the electronic device 500a displays options for selecting the messaging conversation to send a message to in response to the input illustrated in FIG. 10A, as shown in FIG. 10B. In some embodiments, because the user associated with indication 1040e received the shared document via e-mail (and not via a messaging conversation), the electronic device 500a does not display an option for sending a message to that user in response to the input in FIG. 10A, as shown in FIG. 10B.

FIG. 10B illustrates the electronic device 500a updating the document viewing and/or editing user interface in response to the input illustrated in FIG. 10A. As shown in FIG. 10B, the electronic device 500a displays an indication 1004 with options 1008a and 1008b for viewing one of two messaging conversations associated with the shared document and an option 1008c to cease display of the indication 1004 and display the document viewing and/or editing user interface illustrated in FIG. 10A without displaying a messaging conversation. For example, the indication 1004 includes an option 1008a to view a “Family” messaging conversation that includes “Mom” and “Dad” and an option 1008b to view a “Bob & Eve” messaging conversation that includes “Bob” and “Eve.” As shown in FIG. 10B, the electronic device 500a receives an input (e.g., including contact 1003b) selecting option 1008b to view the “Bob & Eve” messaging conversation. In response to the input in FIG. 10B, the electronic device 500a displays the “Bob & Eve” messaging conversation shown in FIG. 10C. In some embodiments, if the electronic device 500a instead received an input selecting option 1008a, the electronic device 500a would display the “Family” messaging conversation in a manner similar to the manner in which the electronic device 500a displays the “Bob & Eve” messaging conversation in FIG. 10C.

FIG. 10C illustrates the electronic device 500a displaying a messaging conversation associated with the shared document in response to the input illustrated in FIG. 10B. In some embodiments, as shown in FIG. 10C, the electronic device 500a ceases display of the shared document when displaying the messaging conversation. In some embodiments, the electronic device 500a displays the messaging conversation overlaid on the shared document.

As shown in FIG. 10C, in response to the input in FIG. 10B, the electronic device 500a displays a representation 1031b of a message sharing the shared document and a representation 1029a of a message that is a reply to the message sharing the shared document overlaid on representations 1030a, 1030b, 1026a, and 1026b of messages in the messaging conversation that include representations 1026a and 1030a of messages not related to the message sharing the shared document, a representation 1030b of the message sharing the shared document, and a representation 1026a of the message that is the reply to the message sharing the shared document. In some embodiments, representations 1031b and 1029a are displayed overlaid on other representations 1030b and 1026a of the same messages, respectively. In some embodiments, the representations 1031b and 1029a are not overlaid on other representations of the same messages. In some embodiments, there are representations of additional messages between representations 1030b and 1026a that are not displayed overlaid on representations 1030b and 1026a (e.g., between representations 1031b and 1029a. In some embodiments, representations 1030a, 1030b, 1026a, and 1026b are displayed with visual de-emphasis (e.g., blurring, darkening, lightening, and/or translucency) relative to the representations 1031b and 1029a. In some embodiments, instead of displaying representations 1031b and 1029a overlaid on the other representations, the electronic device 500a displays the representation 1031b overlaid on the other representations without displaying representation 1029a overlaid on the other representations. In some embodiments, the representations 1031b of the message sharing the shared document has one or more characteristics in common with representations of messages sharing shared documents described above with reference to method 900, including an indication 1013a of the title of the document and an option 1013e to access the document.

In some embodiments, the user interface further includes a message composition field 1027 and, in response to receiving an input composing a message in the message composition field 1027 and selection of the send option 1028b, the electronic device 500a sends a message to the messaging conversation that is a reply to the message sharing the shared document. In some embodiments, in response to receiving inputs composing a message in the message composition field 1027 followed by selection of the send option 1028b while displaying the messaging conversation without representation 1031b and/or representation 1027b overlaid on the other representations, the electronic device 500a sends a message to the messaging conversation that is not a reply to another message.

In some embodiments, the electronic devices initiate and/or participate in communication sessions associated with the shared document, such as phone calls and/or videoconferences that include a selectable option to view the shared document while in the communication session. For example, in FIG. 10D, the electronic device 500a displays a user interface element for sharing the shared document 1006. In some embodiments, the electronic device 500a displays the sharing user interface element in response to detecting selection of the sharing option 1002c in the document viewing and/or editing user interface. In some embodiments, the sharing user interface element has one or more characteristics in common with the sharing user interface element described above with reference to method 700. For example, the sharing element includes an indication 1012a of the name of the document, an option 1012b for toggling between read only sharing and read and edit sharing, an option 1012c to display additional settings, options 1016a through 1016d for sharing the document with a particular group of users using a particular communication method, options 1018a through 1018e for sharing the document using a particular communication method with users to be selected before sharing, a copy option 1011a and a favorites option 1011b.

As shown in FIG. 10D, the electronic device 500a receives an input (e.g., including contact 1003d) selecting an option 1018d to share the document via a videoconference. In response to receiving a sequence of inputs including the input illustrated in FIG. 10D and one or more additional inputs selecting the users with whom to initiate the videoconference, the electronic device 500a initiates the videoconference with the selected users that includes an option to view the shared document. In some embodiments, the selected users already have access to the shared document. In some embodiments, the selected users do not yet have access to the shared document. In some embodiments, the selected users gain access to the shared document after the videoconference. In some embodiments, the selected users are able to access the shared document during the videoconference, but not after. In some embodiments, the selected users include a mix of users that already have access to the shared document and users that do not yet have access to the shared document.

FIG. 10E illustrates a second electronic device 500b receiving an indication of a videoconference initiated by electronic device 500a in response to the input illustrated in FIG. 10D. In some embodiments, the electronic device 500b is displaying a home screen user interface including application icons 1025d through 1025i when the electronic device 500b receives the indication of the incoming videoconference. In some embodiments, in response to receiving the indication of the incoming videoconference, the second electronic device 500b displays an indication 1024a that includes the name of the user initiating the videoconference, an indication 1024d that the communication session is a videoconference, an option 1024b to reject the incoming videoconference, and an option 1024c to accept the videoconference overlaid on the home screen user interface. In some embodiments, if the second electronic device 500b were displaying a different user interface when the indication of the videoconference was received, the second electronic device 500b would display the indications 1024a through 1024d overlaid on the other user interface. In some embodiments, if the second electronic device 500b was in a sleep mode when the indication of the videoconference was received, the electronic device 500b would display a user interface including the indications 1024a through 1024d in response to the incoming videoconference. As shown in FIG. 10E, the second electronic device 500b receives an input (e.g., including contact 1003e) selecting the option 1024c to accept the videoconference. In response to the input illustrated in FIG. 10E, the second electronic device 500b displays a videoconference user interface shown in FIG. 10F.

FIG. 10F illustrates the second electronic device 500b displaying a videoconference user interface in response to the input illustrated in FIG. 10E. In some embodiments, the videoconference user interface includes a control element that includes the name 1046f of the other user on the videoconference, an option 1046a to view a messaging conversation associated with the videoconference, an option 1046b to adjust the audio volume of the videoconference, an option 1046c to mute or unmute the microphone of electronic device 500b, an option 1046d to toggle the camera of the second electronic device 500b on or off, and a screen sharing option 1426e and a shared document element 1030 overlaid on the contents 1034 of the videoconference. In some embodiments, the contents 1034 of the video conference includes video of the other user participating in the videoconference. In some embodiments, the shared document element 1030 includes an indication 1032a of the title of the document and an option 1032b to view the document. In some embodiments, the document was shared with read only permissions, so the user of the electronic device 500b is able to view the document but not edit the document. In some embodiments, if the document was shared with editing permissions, the user of the electronic device 500b would be able to view and edit the shared document.

As shown in FIG. 10F, the second electronic device 500b receives an input (e.g., including contact 1003f) selecting the option 1032b to view the document. In response to the input in FIG. 10F, the second electronic device 500b displays the document while remaining connected to the videoconference, as shown in FIG. 10G.

FIG. 10G illustrates the second electronic device 500b displaying the shared document while connected to the videoconference in response to the input illustrated in FIG. 10F. In some embodiments, the electronic device 500b displays an indication 1044 that the electronic device 500b is connected to a videoconference while displaying the shared document 1006. In some embodiments, the other electronic device 500a displays the shared document while in the videoconference too. In some embodiments, if the user of the other electronic device 500a edits the shared document, the second electronic device 500b displays the shared document 1006 updated in accordance with the changes made to the document 1006 at the other electronic device 500a (e.g., in real-time). In some embodiments, if the shared document 1006 was shared with editing permissions, it would be possible for the user of the second electronic device 500b to revise the shared document 1006 while in the communication session and the other electronic device 500a would update display of the shared document 1006 to include the revisions made at the second electronic device 500b. In some embodiments, it is possible for the videoconference to include more than two users.

FIG. 11 is a flowchart illustrating an exemplary method 1100 of participating in communication sessions associated with a shared document in accordance with some embodiments of the disclosure. The method 1100 is optionally performed at an electronic device such as device 100, device 300, device 500, device 501, device 510, and device 591 as described above with reference to FIGS. 1A-1B, 2-3, 4A-4B and 5A-5I. Some operations in method 1100 are, optionally combined and/or order of some operations is, optionally, changed.

As described below, the method 1100 provides for interaction with shared documents and/or messaging conversations. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 1100 is performed at an electronic device (e.g., 500a) in communication with a display generation component (e.g., 504a) and one or more input devices, such as in FIG. 10A. For example, the electronic device is the electronic device described above with reference to method(s) 700 and/or 900. In some embodiments, the display generation component has characteristics of the display generation component described above with reference to method(s) 700 and/or 900.

In some embodiments, such as in FIG. 10A the electronic device (e.g., 500a) concurrently displays (1102), via the display generation component, a shared document (e.g., 1006) accessible to a plurality of users and a messaging option (e.g., 1036a) associated with the shared document (e.g., 1006). In some embodiments, the shared document has one or more characteristics of the shared document described above with reference to method(s) 700 and/or 900. In some embodiments, the accessibility of the shared document to the plurality of users has one or more of the characteristics of such accessibility of a shared document described with reference to methods 700 and/or 900. In some embodiments, the electronic device presents the shared document in a document editing user interface of a document (e.g., editing and/or viewing) application that includes the messaging option. In some embodiments, the electronic device displays the messaging option in a menu that includes one or more additional options related to the plurality of users with access to the shared document described in more detail below.

In some embodiments, such as in FIG. 10A, while concurrently displaying the shared document (e.g., 1006) and the messaging option (e.g., 1036a), the electronic device receives (1104), via the one or more input devices, an input (e.g., including contact 1003a) selecting the messaging option (e.g., 1036a).

In some embodiments, in response to receiving the input selecting the messaging option, the electronic device (e.g., 500a) displays (1106), via the display generation component, a messaging conversation accessible to the plurality of users in a messaging user interface of a messaging application. In some embodiments, the messaging conversation has one or more characteristics of the messaging conversations described above with reference to method(s) 700 and/or 900. In some embodiments, the messaging conversation includes the users that have access to the shared document (e.g., and does not include users that do not have access to the shared document). In some embodiments, the messaging conversation includes existing messages between the plurality of users. In some embodiments, the messaging conversation is a new messaging conversation that does not include previous messages. In some embodiments, the electronic device displays the shared document in a document (e.g., viewing and/or editing) application that is different from the messaging application.

In some embodiments, such as in FIG. 10C, the messaging conversation includes a one or more first messages associated with a selectable option to access the shared document and one or more second messages not associated with the selectable option to access the shared document (1108). In some embodiments, the option to access the shared document is included in a rich object included in the messaging conversation. For example, in response to receiving an indication of the shared document being shared with the participants in the messaging conversation, the electronic device displays a rich message in the messaging conversation that includes the title of the shared document and the option that, when selected, causes the electronic device to access and/or display the shared document. In some embodiments, one or more first messages are replies to the rich message (or replies to a messaging thread of replies that includes the rich message) that includes the selectable option to access the shared document. In some embodiments, one or more second messages are other messages in the messaging conversation that are not replies to the rich message that includes the selectable option. For example, a message in the messaging conversation that is about the shared document but is not a reply to the message including the selectable option to access the shared document (or replies to a messaging thread of replies that includes the rich message) is included in one or more second messages.

In some embodiments, such as in FIG. 10C, the messaging user interface includes first representations (e.g., 1031b and/or 1027a) of one or more first messages displayed overlaid on (optionally second representations of one or more first messages and) representations (e.g., 1026b and/or 1030a) of one or more second messages (1110). In some embodiments, the electronic device displays the rich message including the selectable option to access the shared document overlaid on the second representations of one or more first messages and the representations of one or more second messages. In some embodiments, the electronic device displays the first representations of one or more first messages overlaid on the second representations of one or more first messages and the representations of one or more second messages with a blurred and/or translucent visual effect. In some embodiments, the messaging user interface further includes a message composition field. In some embodiments, in response to a sequence of inputs composing a message in the message composition field and an input to send the message, the electronic device transmits the message to the messaging conversation as a reply to the rich message including the selectable option to access the shared document (or a reply to a messaging thread of replies that includes the rich message). For example, the composed message is included in one or more first messages once it is sent. Displaying the messaging user interface in response to detecting selection of the messaging option while displaying the shared document enhances user interactions with the electronic device by reducing the number of inputs needed to send a message associated with the selectable option to access the shared document.

In some embodiments, while displaying, via the display generation component (e.g., 504a), the shared document (1106) without displaying the messaging option (e.g., 1036a in FIG. 10A), the electronic device (e.g., 500a) displays, via the display generation component, a menu option (e.g., 1002d) concurrently with the shared document (1006). In some embodiments, the menu option is displayed in the document (e.g., editing and/or viewing) application user interface concurrently with the shared document. In some embodiments, the document (e.g., editing and/or viewing) application user interface further includes an option to navigate back in the user interface and cease displaying the shared document, an option to view formatting settings for the document, a share option described above with reference to method 900, and/or a proofreading option.

In some embodiments, while displaying, via the display generation component (e.g., 504a), the shared document (1106) without displaying the messaging option (e.g., 1036a in FIG. 10A), the electronic device (e.g., 500a) receives, via the one or more input devices, an input selecting the menu option (e.g., 1002d).

In some embodiments, in response to receiving the input selecting the menu option, the electronic device (e.g., 500a) displays a menu (e.g., 1042) that includes the messaging option (e.g., 1036a), an option (e.g., 1036b and/or 1036c) that, when selected, causes the electronic device (e.g., 500a) to contact the plurality of users via an application other than the messaging application (e.g., via a phone application and/or videoconference application), a plurality of indications (e.g., 1040a through 1040c) of users included in the plurality of users, and an option (e.g., 1034b) that, when selected, causes the electronic device to initiate a process to change a setting associated with sharing the shared document (e.g., 1006), such as in FIG. 10A. In some embodiments, the indications of users included in the plurality of users include name(s) and or image(s) associated with the users. In some embodiments, in response to detecting selection of an indication of a respective user, the electronic device displays a contact card user interface for that user. In some embodiments, the setting associated with sharing the shared document is a permissions setting with the options to allow the users to view the document without editing the document or to allow the users to view and edit the document. Displaying the menu enhances user interactions with the electronic device by reducing the number of inputs needed to view various information and settings associated with the shared document.

In some embodiments, the menu (e.g., 1042) further includes an indication (e.g., 1038a and/or 1038b) of a previous change made to the shared document (e.g., 1006) by one of the plurality of users. In some embodiments, the indication indicates the user that made the change to the shared document. In some embodiments, the indication includes an indication of the contents of the change. In some embodiments, the indication does not include an indication of the contents of the change. In some embodiments, the indication is an indication of the document being created. In some embodiments, the indication is an indication of adding and/or removing users from access to the shared document. In some embodiments, the menu does not include indications of when users were added and/or removed from access to the shared document. Displaying the indication of the previous change in the menu enhances user interactions with the electronic device by reducing the number of inputs needed to view various information and settings associated with the shared document.

In some embodiments, such as in FIG. 8O, while displaying the shared document (e.g., 806), the electronic device (e.g., 500a) displays, via the display generation component (e.g., 504a), a visual indication (e.g., 834g and/or 834a) of the messaging conversation accessible to the plurality of users. In some embodiments, the visual indication is an image associated with the messaging conversation. In some embodiments, the image associated with the messaging conversation is selected in a settings user interface for the messaging conversation in the messaging application. In some embodiments, the image associated with the messaging conversation is an automatically generated combination of images associated with the users in the messaging conversation. In some embodiments, the visual indication of the messaging conversation is the name of the messaging conversation set in the settings user interface for the messaging conversation in the messaging application. In some embodiments, the visual indication of the messaging conversation is the names of the users in the messaging conversation. Displaying the visual indication of the messaging conversation enhances user interactions with the electronic device by providing improved visual feedback to the user.

In some embodiments, such as in FIG. 10C, the selectable option (e.g., 1013c) to access the shared document is included in a representation (e.g., 1031b) of a message included in the one or more first messages. In some embodiments, the representation of the message is a representation of the message that included sharing the document with the users in the messaging conversation. In some embodiments, the representation of the message is described in more detail above. In some embodiments, the representation of the message includes the title of the shared document, an indication of the document application for viewing and/or editing the document, and/or an indication of the sharing permissions (e.g., view only or view and edit) extended to the users with access to the shared document. In some embodiments, the representation of the message is displayed in proximity to an indication of the user that shared the shared document. Displaying the selectable option to access the shared document in the representation of the message enhances user interactions with the electronic device by providing an efficient way to access a document shared with the users in the messaging conversation.

In some embodiments, such as in FIG. 10C, one or more first messages include a first message sharing the shared document (e.g., associated with representation 1030b) and one or more messages that are replies to the first message (e.g., associated with representation 1027a). In some embodiments, the electronic device displays indications of messages that are replies to the first message with visual indications associating the replies with the first message. In some embodiments, the electronic device displays a copy of the indication of the first message proximate to the representations of one or more replies to the first message. In some embodiments, while displaying the messaging conversation including representations of messages that are replies to the first message and representations of messages that are not replies to the first message, in response to detecting selection of an indication of replies to the first message, the electronic device displays the first message and the replies to the first message. In some embodiments, the first messages do not include messages in the messaging conversation that are not the message sharing the shared document or replies to the message sharing the shared document. In some embodiments, messages in the messaging conversation that are not the message sharing the shared document or replies to the message sharing the shared document are included in the one or more second messages. Displaying the one or more messages that are replies to the first message overlaid on the other messages in the messaging conversation in response to receiving the input selecting the messaging option enhances user interactions with the electronic device by reducing the inputs needed to view messages related to the shared document.

In some embodiments, the one or more first messages include a first message sharing the shared document (e.g., associated with representation 1031b) and the one or more second messages include one or more messages that are replies to the first message, such as not including representation 1027a in FIG. 10C. In some embodiments, the replies to the first message have one or more characteristics described above. In some embodiments, in response to detecting the input, the electronic device displays the first message overlaid on the other messages in the messaging conversation without displaying the replies to the first message overlaid on the other messages in the messaging conversation. In some embodiments, the first message is displayed overlaid on representations of messages that are replies to the first message and representations of messages that are not replies to the first message. Displaying the first message overlaid on the other messages in the messaging conversation, including replies to the first message, in response to receiving the input selecting the messaging option enhances user interactions with the electronic device by reducing clutter in the user interface showing the first message.

In some embodiments, displaying the messaging conversation in response to receiving the input selecting the messaging option includes displaying the messaging conversation overlaid on the shared document, such as displaying messaging conversation from FIG. 10C overlaid on the document 1006 in FIG. 10A. In some embodiments, the messaging conversation is displayed in the document (e.g., sharing and/or editing) application. In some embodiments, the messaging conversation is displayed in a messaging application user interface overlaid on the document (e.g., sharing and/or editing) application user interface. In some embodiments, the shared document is displayed in the messaging application user interface with the messaging conversation. In some embodiments, while displaying the messaging conversation overlaid on the shared document, at least a portion of the shared document is visible and/or available for interaction. Displaying the messaging conversation overlaid on the shared document enhances user interactions with the electronic device by reducing the inputs needed to view the shared document while viewing the messaging conversation.

In some embodiments, such as in FIG. 10A, while displaying the shared document (e.g., 1006), in accordance with a determination that the shared document (e.g., 1006) is shared with the plurality of users in the messaging conversation and a second plurality of users in a second messaging conversation (e.g., the shared document is shared in multiple messaging conversations), while displaying the shared document without displaying the messaging option, the electronic device (e.g., 500a) displays, via the display generation component (e.g., 504a), a respective option (e.g., 1036a). In some embodiments, the respective option is an option to view one of the messaging conversations with which the shared document is shared. In some embodiments, if the shared document is shared with one messaging conversation, the electronic device displays an option to access the messaging conversation. In some embodiments, if the shared document is shared with multiple messaging conversations, the electronic device displays an option to view options for accessing respective ones of the multiple messaging conversations.

In some embodiments, such as in FIG. 10A, while displaying the shared document (e.g., 1006), in accordance with a determination that the shared document (e.g., 1006) is shared with the plurality of users in the messaging conversation and a second plurality of users in a second messaging conversation (e.g., the shared document is shared in multiple messaging conversations), while displaying the shared document without displaying the messaging option, the electronic device (e.g., 500a) receives, via the one or more input devices, an input (e.g., including contact 1003a) selecting the respective option (e.g., 1036a).

In some embodiments, while displaying the shared document, in response to receiving the input selecting the respective option (e.g., 1036a), such as in FIG. 10A, the electronic device (e.g., 500a) concurrently displays, via the display generation component, a second messaging option (e.g., 1008a) associated with the second messaging conversation and the messaging option (e.g., 1008b) with the shared document (e.g., 1006). In some embodiments, the messaging option and the second messaging option are displayed overlaid on the shared document in the user interface.

In some embodiments, such as in FIG. 10B, while displaying the shared document (e.g., 1006), while concurrently displaying the second messaging option (e.g., 1008b), the messaging option (e.g., 1008a), and the shared document (e.g., 1006), the electronic device (e.g., 500a) receives, via the one or more input devices, an input (e.g., including contact 1003b) selecting the second messaging option (e.g., 1008b).

In some embodiments, in response to receiving the input (e.g., including contact 1003b) selecting the second messaging option (e.g., 1008b), such as in FIG. 10B, the electronic device (e.g., 500a) displays, via the display generation component (e.g., 504a), the second messaging conversation accessible to the second plurality of users in the messaging user interface (e.g., 1020) of the messaging application (e.g., without displaying the messaging conversation). In some embodiments, displaying the second messaging conversation includes displaying representations of one or more messages associated with a selectable option to view the shared document in the second messaging conversation overlaid on representations of one or more messages not associated with the selectable option in a manner similar to the manner described above. In some embodiments, the first messaging conversation and the second messaging conversation are associated with the same messaging application. Displaying the communication option and the second communication option in response to detecting selection of the respective option enhances user interactions with the electronic device by reducing the number of selectable options displayed prior to selection of the respective option, thereby decluttering the user interface.

In some embodiments, the shared document (e.g., 1006) is shared with the plurality of users in the messaging conversation and a respective user, and the shared document was shared with the respective user via an application other than the messaging application, such as in FIG. 10A. In some embodiments, the application is an e-mail application, a second messaging application, or a social media application.

In some embodiments, in response to receiving the input (e.g., including contact 1003b) selecting the messaging option (e.g., 1008b), such as in FIG. 10B, the electronic device (e.g., 500a) forgoes displaying a user interface of the application other than the messaging application. In some embodiments, the electronic device displays the messaging conversation in response to receiving the input selecting the messaging option without displaying a second messaging option associated with messaging the respective user (e.g., via the messaging application or via the application other than the messaging application). In some embodiments, the electronic device displays an option for contacting the respective user via the application other than the messaging application before receiving the input selecting the messaging option. In some embodiments, the electronic device does not display an option for contacting the respective user via the application other than the messaging application. Forgoing displaying the user interface of the application other than the messaging application in response to the input selecting the messaging option enhances user interactions with the electronic device by reducing the number of inputs it takes to view the messaging conversation in the messaging application.

In some embodiments, such as in FIG. 10A, the electronic device (e.g., 500a) concurrently displays, via the display generation component (e.g., 504a), a communication option (e.g., 1036b and/or 1036c) with the shared document (e.g., 1006) and the messaging option (e.g., 1036a). In some embodiments, the communication option is associated with a communication application, such as a phone application and/or a videoconferencing application.

In some embodiments, while concurrently displaying the communication option (e.g., 1036b and/or 1036c), the shared document (e.g., 1006), and the messaging option (e.g., 1036a), such as in FIG. 10A, the electronic device (e.g., 500a) receives, via the one or more input devices, an input selecting the communication option.

In some embodiments, in response to receiving the input selecting the communication option (e.g., 1036b and/or 1036c in FIG. 10A), the electronic device (e.g., 500a) initiates a communication session with the plurality of users that includes a selectable option (e.g., 1032b) to view the shared document, such as in FIG. 10F. In some embodiments, in response to receiving the input, the electronic device places a phone call to the plurality of users and causes the electronic devices of the plurality of user's to display a selectable option that, when selected, causes the electronic devices to display the shared document during the phone call. In some embodiments, in response to receiving the input, the electronic device initiates a videoconference with the plurality of users and causes the electronic devices of the plurality of user's to display a selectable option that, when selected, causes the electronic devices to display the shared document during the videoconference. Displaying the communication option in the user interface with the shared document enhances user interactions with the electronic device by reducing the number of inputs it takes to contact the plurality of users with access to the shared document.

In some embodiments, while not displaying the shared document or the messaging option, such as in FIG. 10E, the electronic device (e.g., 500b) receives an indication of an incoming communication session associated with the shared document. In some embodiments, the communication session is a phone call or a videoconference. In some embodiments, the incoming communication session is sent to the plurality of users with access to the shared document (e.g., including the user of the electronic device) from one of the users with access to the shared document. In some embodiments, the indication of the incoming communication session is received while the electronic device is displaying a user interface of an application other than a document application associated with the shared document or a communication application associated with the communication session. In some embodiments, the indication of the incoming communication session is received while the electronic device is not displaying a user interface (e.g., while the electronic device and/or display generation component is in a sleep mode).

In some embodiments, while not displaying the shared document or the messaging option, in response to receiving the indication of the incoming communication session and in response to receiving an input (e.g., including contact 1003e) to initiate the communication session, such as in FIG. 10E, the electronic device (e.g., 500b) initiates the communication session and displays, via the display generation component, a selectable option (e.g., 1032b) that, when selected, causes the electronic device (e.g., 500b) to display the shared document, such as in FIG. 10F. In some embodiments, in response to receiving the indication of the incoming communication session, the electronic device displays a selectable option to enter the communication session. In some embodiments, in response to receiving an input corresponding to selection of the option to enter the communication session, the electronic device initiates the communication session and displays the selectable option to display the shared document.

In some embodiments, while not displaying the shared document or the messaging option, the electronic device (e.g., 500b) receives, via the one or more input devices, an input (e.g., including contact 1003f) corresponding to selection of the selectable option (e.g., 1032b) that, when selected, causes the electronic device (e.g., 500b) to display the shared document, such as in FIG. 10F.

In some embodiments, in response to receiving the input (e.g., including contact 1003f) corresponding to selection of the selectable option (e.g., 1032b) that, when selected, causes the electronic device (e.g., 500a) to display the shared document, such as in FIG. 10F, the electronic device (e.g., 500b) displays, via the display generation component (e.g., 504b), the shared document (e.g., 1006) (e.g., while remaining in the communication session). In some embodiments, if the electronic device was displaying a user interface when the indication of the incoming call is received, the electronic device ceases display of the user interface when the electronic device displays the shared document. In some embodiments, if the electronic device was displaying a user interface when the indication of the incoming call is received, the electronic device maintains display of the user interface when the electronic device displays the shared document. In some embodiments, the user that receives the incoming communication that includes the shared document does not have access to the shared document prior to receiving the communication and gains access to the shared document after receiving the communication. In some embodiments, the user that receives the incoming communication has access to the shared document prior to receiving the communication. Displaying a selectable option to view the shared document during the communication session enhances user interactions with the computer system by reducing the number of inputs needed to access the shared document during the communication session.

In some embodiments, the electronic device (e.g., 500a) displays, via the display generation component (e.g., 504a), an option (e.g., 1018d) to initiate a communication session associated with the shared document (e.g., 1006). In some embodiments, the option is displayed concurrently with the shared document. In some embodiments, the communication session is a phone call or videoconference. In some embodiments, the communication session is initiated with users that did not previously have access to the shared document. In some embodiments, the communication session is initiated with users that previously had access to the shared document.

In some embodiments, while displaying the option (e.g., 1018d) to initiate the communication session associated with the shared document, the electronic device (e.g., 500a) receives, via the one or more input devices, an input (e.g., including contact 1003d) selecting the option (e.g., 1018d) to initiate the communication session associated with the shared document.

In some embodiments, in response to receiving the input (e.g., including contact 1003d) selecting the option (e.g., 1018d) to initiate the communication session associated with the shared document, such as in FIG. 10D, the electronic device (e.g., 500a) initiates the communication session via a first application (e.g., a communication application associated with the communication session), wherein the communication session includes a selectable option (e.g., 1032b) that, when selected, causes the electronic device (e.g., 500b) to display the shared document in a user interface of a second application (e.g., a document viewing and/or editing application) different from the first application, such as in FIG. 10F. In some embodiments, the option to initiate the communication session is displayed in a user interface of the second application. In some embodiments, the option to initiate the communication session is displayed in a user interface of the first application. In some embodiments, in response to detecting selection of the selectable option for displaying the shared document, the electronic device displays the shared document while remaining in the communication session. In some embodiments, the electronic device displays a user interface from which the user selects one or more users with whom to initiate the communication session. In some embodiments, the one or more users include users that already have access to the shared document, users that do not yet have access to shared document, and/or a mix of users that already have access to the shared document and users that do not yet have access to the shared document. In some embodiments, users that did not previously have access to the shared document gain access to the shared document through the communication session. Initiating a communication session that includes an option to cause the electronic device to display the shared document enhances user interactions with the electronic device by reducing the inputs needed to view the shared document during the communication session.

It should be understood that the particular order in which the operations in FIG. 11 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method(s) 700 and/or 900) are also applicable in an analogous manner to method 1100 described above with respect to FIG. 11. For example, the operation of the electronic device participating in communication sessions associated with a shared document in accordance with some embodiments of the disclosure described above with reference to method 1100 optionally has one or more of the characteristics of presenting indications of changes to a shared document and/or to the users in a messaging conversation while displaying the messaging conversation and/or presenting options to update the users with access to shared documents and/or messaging conversations described herein with reference to other methods described herein (e.g., method(s) 700 and/or 900). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 11 are, optionally, implemented by components depicted in FIGS. 1A-1B. For example, displaying operations 1102 and/or 1106 and/or receiving operation 1104 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to facilitate sharing documents and participation in messaging conversations. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, etc.

The present disclosure recognizes that the use of such personal information data, in the present technology, can be used to the benefit of users. For example, the personal information data can be used to allow and/or deny access to messaging conversations and/or shared documents. Accordingly, use of such personal information data enables users to enter fewer inputs to perform an action with respect to messaging conversations and/or shared documents. Further, other uses for personal information data that benefit the user are also contemplated by the present disclosure. For instance, stored contact information may be used to share messaging conversations and/or shared documents.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain identifying information of the user.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, shared documents and/or messages can be accessed on authorized devices but not on unauthorized devices.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
concurrently displaying, via the display generation component, a shared document accessible to a plurality of users and a messaging option associated with the shared document;
while concurrently displaying the shared document and the messaging option:
receiving, via the one or more input devices, an input selecting the messaging option; and
in response to receiving the input selecting the messaging option:
displaying, via the display generation component, a messaging conversation accessible to the plurality of users in a messaging user interface of a messaging application, wherein:
the messaging conversation includes one or more first messages associated with a selectable option to access the shared document and one or more second messages not associated with the selectable option to access the shared document, and
the messaging user interface includes first representations of one or more first messages displayed overlaid on representations of one or more second messages.

2. The method of claim 1, further comprising:
while displaying, via the display generation component, the shared document without displaying the messaging option:
displaying, via the display generation component, a menu option concurrently with the shared document; and
receiving, via the one or more input devices, an input selecting the menu option; and
in response to receiving the input selecting the menu option, displaying a menu that includes the messaging option, an option that, when selected, causes the electronic device to contact the plurality of users via an application other than the messaging application, a plurality of indications of users included in the plurality of users, and an option that, when selected, causes the electronic device to initiate a process to change a setting associated with sharing the shared document.

3. The method of claim 2, wherein the menu further includes an indication of a previous change made to the shared document by one of the plurality of users.

4. The method of claim 1, further comprising:
while displaying the shared document, displaying, via the display generation component, a visual indication of the messaging conversation accessible to the plurality of users.

5. The method of claim 1, wherein the selectable option to access the shared document is included in a representation of a message included in the one or more first messages.

6. The method of claim 1, wherein one or more first messages include a first message sharing the shared document and one or more messages that are replies to the first message.

7. The method of claim 1, wherein the one or more first messages include a first message sharing the shared document and the one or more second messages include one or more messages that are replies to the first message.

8. The method of claim 1, wherein displaying the messaging conversation in response to receiving the input selecting the messaging option includes displaying the messaging conversation overlaid on the shared document.

9. The method of claim 1, further comprising:
while displaying the shared document:
in accordance with a determination that the shared document is shared with the plurality of users in the messaging conversation and a second plurality of users in a second messaging conversation, while displaying the shared document without displaying the messaging option:
displaying, via the display generation component, a respective option; and
receiving, via the one or more input devices, an input selecting the respective option; and
in response to receiving the input selecting the respective option, concurrently displaying, via the display generation component, a second messaging option associated with the second messaging conversation and the messaging option with the shared document;
while concurrently displaying the second messaging option, the messaging option, and the shared document, receiving, via the one or more input devices, an input selecting the second messaging option; and
in response to receiving the input selecting the second messaging option, displaying, via the display generation component, the second messaging conversation accessible to the second plurality of users in the messaging user interface of the messaging application.

10. The method of claim 1, wherein the shared document is shared with the plurality of users in the messaging conversation and a respective user, and the shared document was shared with the respective user via an application other than the messaging application, and the method further comprises:
in response to receiving the input selecting the messaging option, forgoing displaying a user interface of the application other than the messaging application.

11. The method of claim 1, further comprising:
concurrently displaying, via the display generation component, a communication option with the shared document and the messaging option;
while concurrently displaying the communication option, the shared document, and the messaging option, receiving, via the one or more input devices, an input selecting the communication option; and
in response to receiving the input selecting the communication option, initiating a communication session with the plurality of users that includes a selectable option to view the shared document.

12. The method of claim 1, further comprising:
while not displaying the shared document or the messaging option:
receiving an indication of an incoming communication session associated with the shared document;
in response to receiving the indication of the incoming communication session and in response to receiving an input to initiate the communication session, initiating the communication session and displaying, via the display generation component, a selectable option that, when selected, causes the electronic device to display the shared document; and
receiving, via the one or more input devices, an input corresponding to selection of the selectable option that, when selected, causes the electronic device to display the shared document; and
in response to receiving the input corresponding to selection of the selectable option that, when selected, causes the electronic device to display the shared document, displaying, via the display generation component, the shared document.

13. The method of claim 1, further comprising:
displaying, via the display generation component, an option to initiate a communication session associated with the shared document;
while displaying the option to initiate the communication session associated with the shared document, receiving, via the one or more input devices, an input selecting the option to initiate the communication session associated with the shared document; and
in response to receiving the input selecting the option to initiate the communication session associated with the shared document:
initiating the communication session via a first application, wherein the communication session includes a selectable option that, when selected, causes the electronic device to display the shared document in a user interface of a second application different from the first application.

14. An electronic device, comprising:
one or more processors;
memory; and
one or more programs, wherein the one or more programs are stored in the memory and configured to be executed by the one or more processors, the one or more programs including instructions for:
concurrently displaying, via a display generation component, a shared document accessible to a plurality of users and a messaging option associated with the shared document;
while concurrently displaying the shared document and the messaging option:
receiving, via one or more input devices, an input selecting the messaging option; and
in response to receiving the input selecting the messaging option:
displaying, via the display generation component, a messaging conversation accessible to the plurality of users in a messaging user interface of a messaging application, wherein:
the messaging conversation includes a one or more first messages associated with a selectable option to access the shared document and one or more second messages not associated with the selectable option to access the shared document, and
the messaging user interface includes first representations of one or more first messages displayed overlaid on representations of one or more second messages.

15. A non-transitory computer readable storage medium storing one or more programs, the one or more programs comprising instructions, which when executed by one or more processors of an electronic device, cause the electronic device to perform a method comprising:
concurrently displaying, via a display generation component, a shared document accessible to a plurality of users and a messaging option associated with the shared document;
while concurrently displaying the shared document and the messaging option:
receiving, via one or more input devices, an input selecting the messaging option; and
in response to receiving the input selecting the messaging option:
displaying, via the display generation component, a messaging conversation accessible to the plurality of users in a messaging user interface of a messaging application, wherein:
the messaging conversation includes a one or more first messages associated with a selectable option to access the shared document and one or more second messages not associated with the selectable option to access the shared document, and
the messaging user interface includes first representations of one or more first messages displayed overlaid on representations of one or more second messages.
